(19) United States
(12) Patent Application Publication
(10) Pub. No.: US 2026/0162114 A1
(43) Pub. Date: Jun. 11, 2026

(54) ELECTRONIC DEVICE, APPLICATION SERVER, AND OPERATION METHOD FOR REGISTERING CARD LINKED WITH IDENTIFICATION INFORMATION

(71) Applicant: SAMSUNG ELECTRONICS CO., LTD., Suwon-si (KR)

(72) Inventors: Youna LEE, Suwon-si (KR); Miyeon Kil, Suwon-si (KR); Jihyun Kim, Suwon-si (KR); Jaeyoung Shin, Suwon-si (KR); Seonghoon You, Suwon-si (KR); Hyeongseok Lee, Suwon-si (KR); Namin Kim, Suwon-si (KR); Dongyeop Kim, Suwon-si (KR); Kwangsoo Park, Suwon-si (KR); Jaesung Son, Suwon-si (KR)

(73) Assignee: SAMSUNG ELECTRONICS CO., LTD., Suwon-si (KR)

(21) Appl. No.: 19/465,301

(22) Filed: Jan. 30, 2026

Related U.S. Application Data
(63) Continuation of application No. PCT/KR2025/017888, filed on Nov. 4, 2025.

(30) Foreign Application Priority Data
Nov. 4, 2024 (KR) 10-2024-0154540
Jan. 8, 2025 (KR) 10-2025-0002596

(51) Int. Cl. G06Q 20/40; G06Q 10/02; H04L 9/32

(52) U.S. Cl. CPC G06Q 20/40145; H04L 9/3236; G06Q 10/02

(57) ABSTRACT

An electronic device includes a transceiver; a display; at least one processor including processing circuitry; and memory including instructions. The instructions, based on execution by the at least one processor individually or collectively, may cause the electronic device to: identify a card in an application, display, based on determining that the card is of a type that requires linkage with an ID card, a first user (UI)—requesting a user input—on the display, obtain, based on the user input, a first ID information, and register the card in the application by linking the card to the first ID information.

### CROSS-REFERENCE TO RELATED APPLICATION(S)

This application is a by-pass continuation application of International application No. PCT/KR2025/017888, filed on Nov. 4, 2025, which is based on and claims priority to Korean Patent Application No. 10-2024-0154540, filed on Nov. 4, 2024, and Korean Patent Application No. 10-2025-0002596, filed on Jan. 8, 2025, in the Ministry of Intellectual Property, the disclosures of which are incorporated by reference herein in its entirety.

### BACKGROUND

### 1. Field

The disclosure relates to an electronic device, application server, and operation method for registering a card linked with identification information.

### 2. Description of Related Art

As digital technology advances and the Internet becomes more widespread, numerous services are transitioning from offline to online. For example, consumers may purchase tickets for performances, sports events, concerts, or fairs conveniently through online platforms. The process of purchasing tickets online is gaining traction as it enables users to conveniently buy tickets at any time and from any location.

While online ticket purchasing may offer convenience to consumers, it also presents the risk of various issues, including ticket resale and theft. Accordingly, the need to enhance authentication for ticket users is increasing.

### SUMMARY

Provided are an electronic device, application server, and operation method for registering a card linked with identification (ID) information.

Provided are an electronic device, application server, and operation method thereof, enabling the use of an authenticated ticket based on ID information.

Provide are an electronic device, application server, and operation method capable of preventing ticket resale and theft.

Provided are an electronic device, application server, and operation method, capable of simplifying an admission procedure and reducing time and cost according to ticket inspection.

Additional aspects will be set forth in part in the description which follows and, in part, will be apparent from the description, or may be learned by practice of the presented embodiments.

According to an aspect of the disclosure, an electronic device may include a transceiver; a display; at least one processor including processing circuitry; and memory including instructions. The instructions, based on execution by the at least one processor individually or collectively, may cause the electronic device to: identify a card in an application, display, based on determining that the card is of a type that requires linkage with an ID card, a first user (UI)—requesting a user input—on the display, obtain, based on the user input, a first ID information, and register the card in the application by linking the card to the first ID information.

The instructions, based on execution by the at least one processor individually or collectively, may cause the electronic device to: receive a card registration request message from an application server through the transceiver, identify information about the card based on the card registration request message, and display the card on the display based on the identified information.

The instructions, based on execution by the at least one processor individually or collectively, may cause the electronic device to: based on the card being a ticket type card, determine that the card is of the type that requires linkage with the ID card.

The instructions, based on execution by the at least one processor individually or collectively, may cause the electronic device to: based on the user input, display a second UI for biometric authentication on the display, and based on the biometric authentication, obtain the first ID information.

The instructions, based on execution by the at least one processor individually or collectively, may cause the electronic device to: based on the user input, display the ID card for identity authentication on the display, based on the display of the ID card, display a second UI for biometric authentication on the display, and based on the biometric authentication being successful, update the ID card to include a personal information and obtain the first ID information based on the personal information, wherein the personal information includes information obtained from an authentication server.

The instructions, based on execution by the at least one processor individually or collectively, may cause the electronic device to: generate a first hash value based on the personal information, request authentication for the first hash value from the authentication server, and based on receiving a message indicating that authentication for the first hash value has been successful from the authentication server, obtain the first ID information based on the first hash value.

The instructions, based on execution by the at least one processor individually or collectively, may cause the electronic device to: transmit, a card registration response message to an application server via the transceiver, wherein the card registration response message indicates that the card is linked to the first ID information and is registered in the application.

The instructions, based on execution by the at least one processor individually or collectively, may cause the electronic device to: based on the biometric authentication failing, register the card in the application without linking the first ID information, and transmit a card registration response message to the application server via the transceiver. The card registration response message indicates that the card is registered in the application without linking the first ID information.

The instructions, based on execution by the at least one processor individually or collectively, may cause the electronic device to: based on receiving a request for use of the registered card, perform an ID card authentication, and based on the ID card authentication being successful, display a card data for use of the registered card on the display. The card data may include a quick response (QR) code or a barcode.

The instructions, based on execution by the at least one processor individually or collectively, may cause the electronic device to: obtain a second ID information, determine whether the second ID information corresponds to (e.g., matches) the first ID information, and based on the second ID information corresponding to the first ID information, identify that the ID card authentication is successful, based on the ID card authentication being successful, transmit a request message for requesting the card data to the application server via the transceiver, and in response to the application server receiving the request message, obtain the card data from the application server via the transceiver. The first ID information may include a first hash value, and the second ID information may include a second hash value.

The instructions, based on execution by the at least one processor individually or collectively, may cause the electronic device to: based on the second ID information not corresponding to the first ID information, identify that the ID card authentication has failed, and based on a failure of the ID card authentication, output a notification message indicating that the ID card authentication has failed on the display.

According to an aspect of the disclosure, an application server includes: a transceiver; at least one processor including processing circuitry; memory including instructions. The instructions, based on execution by the at least one processor individually or collectively, cause the application server to: transmit a card registration request message to an electronic device via the transceiver; in response to the electronic device receiving the card registration request message, receive a card registration response message including first ID information from the electronic device via the transceiver; and register the first ID information in association with information about a card. The card registration request message is a request to register the card in an application of the electronic device.

The card registration request message and the card registration response message may each include a card identifier corresponding to the card. The card may be a ticket type card.

The instructions, based on execution by the at least one processor individually or collectively, may cause the application server to: receive a request message for use of the card from the electronic device via the transceiver; determine whether a second ID information included in the request message corresponds to the first ID information; based on the second ID information corresponding to the first ID information, identify that an ID card authentication is successful; based on the ID card authentication being successful, request card data for use of the card from a partner server via the transceiver; and transmit the card data to the electronic device based on receiving the card data from the partner server through the transceiver. The first ID information may include a first hash value, and the second ID information may include a second hash value.

The instructions, based on execution by the at least one processor individually or collectively, may cause the application server to: based on the second ID information not corresponding to the first ID information, identify that the ID card authentication has failed, and based on a failure of the ID card authentication, transmit a notification message indicating that the ID card authentication has failed to the electronic device through the transceiver.

According to an aspect of the disclosure a method for operating an electronic device may be provided. The method may include: identifying a card to be registered in an application; displaying, based on determining that the card is of a type that requires linkage with an ID card, a first user interface (UI)—requesting a user input—on a display of the electronic device, obtaining, based on the user input, a first ID information; and registering the card in the application by linking the card to the first ID information.

Obtaining the first ID information may include: based on the user input, displaying the ID card for an identity authentication on the display; based on the display of the ID card, displaying a second UI for performing the identity authentication through a biometric authentication on the display; and based on the biometric authentication being successful, updating the ID card to include a personal information and generating the first ID information based on the personal information. The personal information may include information obtained from the authentication server.

Generating the first ID information may include: generating a first hash value based on the personal information; requesting authentication for the first hash value from the authentication server; and based on receiving a message indicating that authentication for the first hash value has been successful from the authentication server, generating the first ID information based on the first hash value.

According to an aspect of the disclosure, a method for operating an application server may be provided. The method may include: transmitting a card registration request message to an electronic device; in response to the electronic device receiving the card registration request message, receiving a card registration response message including first ID information from the electronic device; and registering the first ID information by linking the first ID information to information about a card. The card registration request message is a request to register the card in an application of the electronic device.

The card registration request message and the card registration response message may each include a card identifier corresponding to the card. The card may be a ticket type card.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram illustrating an electronic device 101 in a network environment 100 according to various embodiments;

FIG. 2A is a block diagram schematically illustrating an example configuration of an electronic device according to one or more embodiment(s);

FIG. 2B is a block diagram schematically illustrating an example configuration of an application server according to one or more embodiment(s);

FIG. 3 is a view illustrating an example operation of purchasing a ticket and using a ticket according to one or more embodiment(s);

FIG. 4 is a view schematically illustrating an example configuration and operation of a ticket registration system according to one or more embodiment(s);

FIG. 5 is a view schematically illustrating an example configuration and operation of a ticket use system according to one or more embodiment(s);

FIG. 6 is a view schematically illustrating an example configuration and operation of a ticket use system according to one or more embodiment(s);

FIG. 7A is a flowchart illustrating an example operation of accessing an ID card module to register a ticket type card according to one or more embodiment(s);

FIG. 7B is a flowchart illustrating an example operation of registering a ticket type card according to one or more embodiment(s);

FIG. 8A is a flowchart illustrating an example operation of performing ID card authentication in an application server for ticket use according to one or more embodiment(s);

FIG. 8B is a flowchart illustrating an example operation based on a successful ID card authentication in an application server according to one or more embodiment(s);

FIG. 8C is a flowchart illustrating an example operation based on a failed ID card authentication in an application server according to one or more embodiment(s);

FIG. 9A is a flowchart illustrating an example operation of performing ID card authentication in an application for ticket use according to one or more embodiment(s);

FIG. 9B is a flowchart illustrating an example operation based on an ID card authentication result of an application according to one or more embodiment(s);

FIG. 10A is a view illustrating an example UI screen for adding a ticket to an application according to one or more embodiment(s);

FIG. 10B is a view illustrating an example UI screen for linking ID information to a ticket according to one or more embodiment(s);

FIG. 10C is a view illustrating an example UI screen for linking ID information to a ticket through identifying ID information according to one or more embodiment(s);

FIGS. 11A and 11B is a are views illustrating an example UI screen of an admission ticket displayed on an application according to one or more embodiment(s);

FIG. 12 is a flowchart illustrating an example operation of an electronic device for registering a ticket type card according to one or more embodiment(s);

FIG. 13A is a flowchart illustrating an example operation of an electronic device for obtaining first ID information according to one or more embodiment(s);

FIG. 13B is a flowchart illustrating an example operation of an electronic device for obtaining first ID information based on ID card display according to one or more embodiment(s);

FIG. 14A is a flowchart illustrating an example operation of an electronic device using a ticket type card based on ID card authentication of the electronic device according to one or more embodiment(s);

FIG. 14B is a flowchart illustrating an example operation of an electronic device using a ticket type card based on ID card authentication of an application server according to one or more embodiment(s);

FIG. 15 is a flowchart illustrating an example operation of an application server according to one or more embodiment(s); and

FIG. 16 is a flowchart illustrating an example ID card authentication operation of an application server according to one or more embodiment(s).

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

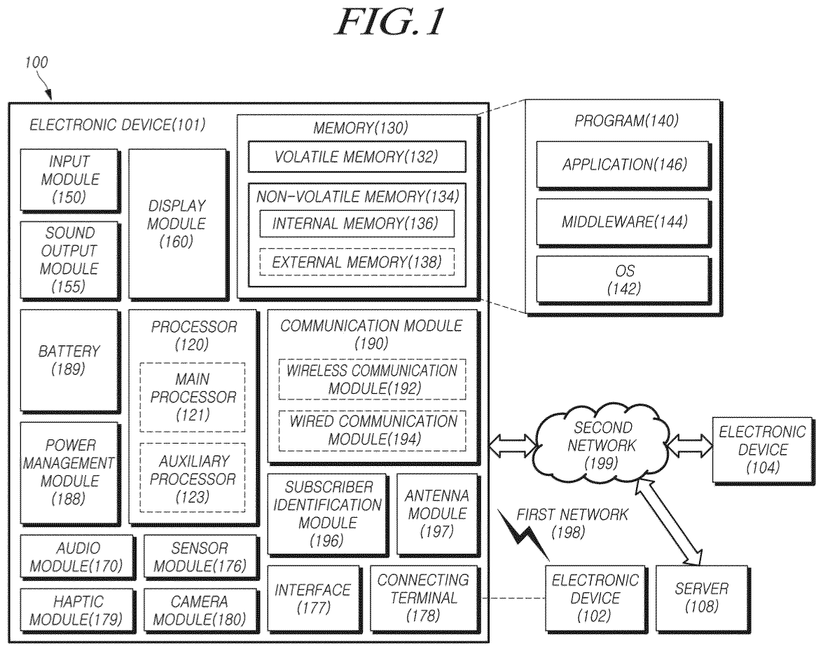

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In an embodiment, at least one of the components (e.g., the connecting terminal 178) may be omitted from the electronic device 101, or one or more other components may be added in the electronic device 101. According to an embodiment, some of the components (e.g., the sensor module 176, the camera module 180, or the antenna module 197) may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and/or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, in case that the electronic device 101 includes the main processor 121 and the auxiliary processor 123, the auxiliary processor 123 may be configured to use lower power than the main processor 121 or may be specified for a designated function. The auxiliary processor 123 may be implemented as separate from, or as a part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence (AI) model processing. The AI model may be generated via machine learning. Such learning may be performed, e.g., by the electronic device 101 where the AI is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), and/or a digital pen (e.g., a stylus pen).

The sound output module 155 may output sound signals to the outside of the electronic device 101. The sound output module 155 may include, for example, a speaker and/or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, and/or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, and/or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, and/or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, and/or a global navigation satellite system (GNSS) communication module) and/or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) and/or a second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and/or authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as beamforming, massive multiple-input and multiple-output (massive MIMO), full dimensional MIMO (FD-MIMO), array antenna, analog beam-forming, and/or large scale antenna. The wireless communication module 192 may support various requirements specified in the electronic device 101, an external electronic device (e.g., the electronic device 104), and/or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, and/or U-plane latency (e.g., 0.5 ms or less for each of downlink (DL) and uplink (UL), or a round trip of 1 ms or less) for implementing URLLC.

The antenna module 197 may transmit or receive a signal from the outside (e.g., the external electronic device). In an embodiment, the antenna module 197 may transmit power to or receive power from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC, and a plurality of antennas (e.g., array antennas). The RFIC may be disposed on a first surface (e.g., the bottom surface) of the printed circuit board, or on a surface adjacent to the first surface of the printed circuit board. The RFIC may be capable of supporting a designated high-frequency band (e.g., the mmWave band). The plurality of antennas may be disposed on a second surface (e.g., the top or a side surface) of the printed circuit board, or on a surface adjacent to the second surface of the printed circuit board. The plurality of antennas may be capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same type or of a different type from the electronic device 101. According to an embodiment, all or some of operations to be executed by the electronic device 101 may be executed by one or more of the external electronic devices (e.g., electronic device 102, electronic device 104, and/or server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform at least part of the function or service requested, or an additional function or additional service related to the request, and transfer an outcome of the performance to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

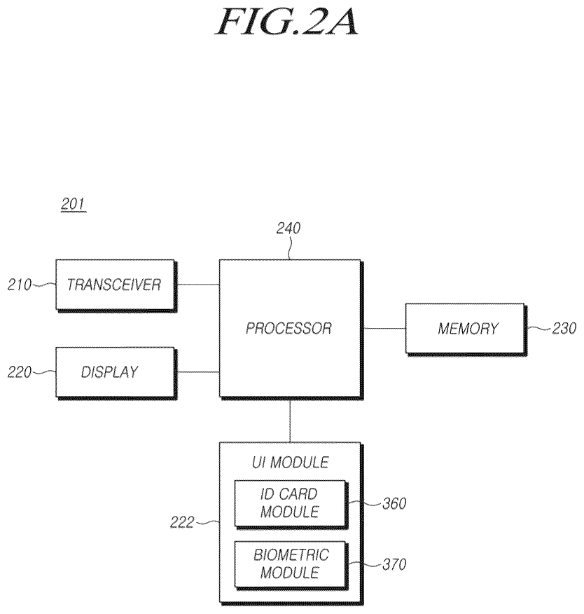

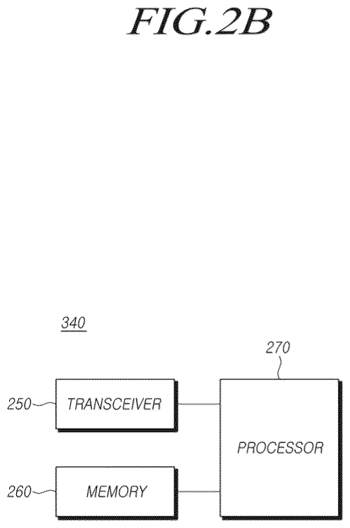

FIG. 2A is a block diagram schematically illustrating an example configuration of an electronic device according to one or more embodiment(s).

Referring to FIG. 2A, an electronic device 201 may include a transceiver 210, a display 220, a UI module 222, memory 230, and a processor 240. According to an embodiment, the electronic device 201 may include an additional component (e.g., the input module 150 or the sensor module 176 of FIG. 1) other than the illustrated components or may omit at least one of the illustrated components. According to an embodiment, the electronic device 201 may include the same or similar components to at least one of the components (e.g., modules) of the electronic device 101 illustrated in FIG. 1. According to an embodiment, the processor 240 may be a plurality of processors (referred to as at least one processor 240)

According to an embodiment, the electronic device 201 may be any one of a mobile device (e.g., a smartphone or tablet), a computing device (e.g., a personal computer (PC) or a notebook), a wearable device (e.g., a smart watch or a head-mounted display (HMD)), or a home appliance (e.g., a TV), and is not limited thereto but may include various other types of electronic devices.

According to an embodiment, the transceiver 210 may be operated independently from the processor 240 (e.g., an AP) and may include one or more CPs and/or communication circuits that support wireless communication or wired communication.

According to an embodiment, the transceiver 210 may include a wireless communication module (e.g., a cellular communication module, a short-range wireless communication module, or a GNSS communication module) or a wired communication module (e.g., a LAN communication module or a PLC module). A corresponding one of these communication modules may communicate with the external electronic device or server via a first network (e.g., a short-range communication network, such as Near Field Communication (NFC), Bluetooth, Bluetooth Low Energy (BLE), Wi-Fi, Wi-Fi Direct (WFD), or Infrared Data Association (IrDA)), or a second network (e.g., a long-range communication network, such as a legacy cellular network, a 5G network, a next-generation communication network, the Internet, or a computer network (e.g., LAN or WAN). These various types of communication modules may be implemented as a single component (e.g., a single chip), or may be implemented as multiple components (e.g., multiple chips) separate from each other.

According to an embodiment, the transceiver 210 may be implemented in substantially the same or similar manner to the communication module 190 of FIG. 1.

According to an embodiment, the display 220 may perform various display operations according to functions of the electronic device 201. For example, the display 220 may display at least one of various service information, media information, graphic information, and/or text information. According to an embodiment, the display 220 may display at least one card that may be used based on the execution of an application (e.g., a wallet application) and may display various information related to the registration and/or use of the at least one card. According to an embodiment, at least one card may be used as a term (e.g., terminology or word) referring to various types of content. For example, at least one card may include various forms of content such as tickets, business cards, boarding passes, employee IDs, passes, or coupons. According to an embodiment, at least one card may have various types (e.g., functions or forms) based on the included content. According to an embodiment, each card included in at least one card may correspond to any one of various types such as a ticket type, a business card type, a boarding pass type, an employee ID type, a pass type, or a coupon type. According to an embodiment, in the following description, the ticket type card may be simply referred to as a ticket. According to an embodiment, each card type may be used for card management for each type.

According to an embodiment, the display 220 may be implemented as a touch screen to enable input and output and may support intuitive interaction between the user and the electronic device 201. For example, the display 220 may be implemented using various touchscreen technologies, such as a resistive (or pressure-sensitive resistive film) type, a capacitive type, or an infrared type. The display 220 may include a touch sensor or a pressure sensor and may support direct manipulation of an icon, button, or graphic object output on the screen using the user's body (e.g., hand or finger) or an input device (e.g., a stylus pen).

According to an embodiment, the display 220 may be implemented as a single independent display or may include a plurality of displays disposed at different positions.

According to an embodiment, the display 220 may be implemented to be identical or similar to the display module 160 of FIG. 1.

According to an embodiment, the UI module 222 may include at least one module for interacting with the user or may include at least one module that operates based on the user's input or selection. For example, the UI module 222 may include an ID card module 360 and a biometric module 370.

According to an embodiment, the ID card module 360 may include a software development kit (SDK) related to ID verification and may obtain and store information related to the ID card (e.g., face information or ID information for identity authentication) from an external authentication server. According to an embodiment, the ID card module 360 may operate in a secure area such as a trusted execution environment (TEE) and may restrict access by an unauthenticated user.

According to an embodiment, the biometric module 370 may include at least one biometric sensor (e.g., a fingerprint sensor, an iris recognition sensor, or a face recognition sensor) and may recognize (e.g., identify, verify, determine) the user's biometrics through at least one biometric sensor. The biometric module 370 may authenticate the recognized biometrics by itself or through communication with an external server. According to an embodiment, the biometric module 370 may perform the user authentication operation for determining whether to allow access to the ID card module 360 and provide an authentication result to the ID card module 360.

According to an embodiment, in addition to biometric authentication, authentication for access to the ID card module 360 may be performed through various authentication methods such as password authentication (e.g., verification) or pattern input authentication (e.g., verification), and an authentication module different from the biometric module 370 may be included according to the authentication (e.g., verification) method used.

According to an embodiment, the memory 230 may store various data used by at least one component (e.g., the transceiver 210, the display 220, the UI module 222, or the processor 240) of the electronic device 201. For example, the memory 230 may store at least one program for processing and controlling the processor 240 and may store input and/or output data. The memory 230 may store at least one AI model (e.g., machine learning model or deep learning model), and may include a volatile memory and/or a non-volatile memory. According to an embodiment, the memory 230 may be implemented to be substantially the same or similar to the memory 130 of FIG. 1.

According to an embodiment of the disclosure, the processor 240 may control the overall operation of the electronic device 201. The processor 240 may perform an operation or data processing related to control and/or communication of at least one other component of the electronic device 201. For example, the processor 240 may be electrically connected to the transceiver 210, the display 220, the UI module 222, and the memory 230 and perform the operations of the electronic device 201 described below.

The processor 240 may include a processing circuit that executes instructions of the program stored in the memory 230. The processor 240 may include at least one of a CPU, a NPU, a GPU, a micro processing unit (MPU), a micro controller unit (MCU), an AP, a CP, a system on chip (SoC), or an integrated circuit (IC) sensor hub, a supplementary processor, an application specific integrated circuit (ASIC), or a field programmable gate arrays (FPGA), and may include a plurality of cores.

The processor 240 may control the operations of the electronic device 201 by executing the instructions stored in the memory 230. For example, the processor 240 may correspond to a plurality of processors that divide a plurality of operations between processors and collectively perform the operations. According to an embodiment, the processor 240 may be implemented to be substantially the same as or similar to the processor 120 of FIG. 1.

An electronic device 201 according to an embodiment may comprise a transceiver 210, a display 220, an ID card module 360, memory 230, and at least one processor 240 including processing circuitry. The memory 230 may store instructions that, based on execution individually or collectively by the at least one processor 240, cause the electronic device 201 to identify a card to be registered in an application, display, based on determining that the card is of a type that requires linkage with an ID card, a first UI for the linkage with the ID card on the display 220, obtain, based on an input based on the first UI being received, first ID information from the ID card module 360, and register the card in the application by linking the card with the first ID information.

According to an embodiment, the memory 230 may store instructions that, based on execution, individually or collectively, by the at least one processor 240, cause the electronic device 201 to receive a card registration request message from an application server through the transceiver 210, identify information about the card based on the card registration request message, and display the card on the display 220 based on the identified information.

According to an embodiment, the memory 230 may store instructions that, based on execution, individually or collectively, by the at least one processor 240, cause the electronic device 201 to, based on the card being a ticket type card, determine that the card is of the type that requires linkage with the ID card.

According to an embodiment, the memory 230 may store instructions that, based on execution, individually or collectively, by the at least one processor 240, cause the electronic device 201 to, based on the input based on the first UI being received, display a second UI for biometric authentication on the display 220, and based on the biometric authentication being successful through the second UI, obtain the first ID information from the ID card module 360.

According to an embodiment, the memory 230 may store instructions that, based on execution, individually or collectively, by the at least one processor 240, cause the electronic device 201 to, based on the input based on the first UI being received, display the ID card for the identity authentication on the display 220 through the ID card module 360, based on the display of the ID card, display a second UI for biometric authentication on the display 220, and based on the biometric authentication being successful through the second UI, update the ID card to include personal information through the ID card module 360 and obtain the first ID information based on the personal information through the ID card module 360. The personal information may include information obtained from the authentication server 380.

According to an embodiment, the memory 230 may store instructions that, based on execution, individually or collectively, by the at least one processor 240, cause the electronic device 201 to generate a first hash value based on the personal information through the ID card module 360, request authentication for the first hash value from the authentication server 380, and based on receiving a message indicating that authentication for the first hash value has been successful from the authentication server 380, generate the first ID information based on the first hash value through the ID card module 360.

According to an embodiment, the memory 230 may store instructions that, based on execution, individually or collectively, by the at least one processor 240, cause the electronic device 201 to transmit, to an application server, a card registration response message indicating that the card is linked to the first ID information and is registered in the application, through the transceiver 210.

According to an embodiment, the memory 230 may store instructions that, based on execution, individually or collectively, by the at least one processor 240, cause the electronic device 201 to register the card in the application without linking the first ID information based on the biometric authentication failing through the second UI, and transmit, to the application server 340, a card registration response message indicating that the card is registered in the application without linking the first ID information, through the transceiver 210.

According to an embodiment, the memory 230 may store instructions that, based on execution, individually or collectively, by the at least one processor 240, cause the electronic device 201 to perform ID card authentication based on receiving a request for use of the registered card, and based on the ID card authentication being successful, display card data for use of the registered card on the display 220. The card data may include a QR code or a barcode.

According to an embodiment, the memory 230 may store instructions that, based on execution, individually or collectively, by the at least one processor 240, cause the electronic device 201 to obtain second ID information through the ID card module, determine whether the second ID information corresponds to the first ID information, and based on the second ID information corresponding to the first ID information, identify that the ID card authentication is successful, based on a success of the ID card authentication, transmit, to the application server, a request message for requesting the card data through the transceiver 210, and in response to the request message, obtain the card data from the application server through the transceiver 210. The first ID information may include a first hash value, and the second ID information may include a second hash value.

According to an embodiment, the memory 230 may store instructions that, based on execution, individually or collectively, by the at least one processor 240, cause the electronic device 201 to identify that the ID card authentication has failed based on the second ID information not corresponding to the first ID information, and output a notification message indicating that the ID card authentication has failed on the display 220 based on a failure of the ID card authentication.

FIG. 2B is a block diagram schematically illustrating an example configuration of an application server according to one or more embodiment(s).

According to an embodiment, the application server 340 is a server on a network associated with an application included in an electronic device (e.g., the electronic device 201 of FIG. 2A) and may perform an operation associated with the application or store various information for providing a service of the application. According to an embodiment, the application may support payment through an electronic device or may correspond to a wallet application, a mobile wallet, an electronic wallet, or an app wallet platform that allows for registration and use of various types of cards (e.g., ID, boarding pass, admission ticket, ticket, or coupon type card).

Referring to FIG. 2B, the application server 340, according to an embodiment, may include a transceiver 250, memory 260, and a processor 270. According to an embodiment, the application server 340 may include additional components in addition to the illustrated components or may omit at least one of the illustrated components. According to an embodiment, the processor 270 may be a plurality of processors (referred to as at least one processor 270).

According to an embodiment, the transceiver 250 may be operated independently of the processor 270 and may include one or more CPs or communication circuits supporting wireless communication or wired communication.

According to an embodiment, the transceiver 250 may include a wireless communication module (e.g., a cellular communication module, a short-range wireless communication module, or a GNSS communication module) or a wired communication module (e.g., a LAN communication module or a PLC module). A corresponding one of these communication modules may communicate with the electronic device (e.g., the electronic device 201 of FIG. 2A) or external server (e.g., a partner server) via a first network (e.g., a short-range communication network, such as NFC, Bluetooth, BLE, Wi-Fi, WFD, or IrDA) or a second network (e.g., a long-range communication network, such as a legacy cellular network, a 5G network, a next-generation communication network, the Internet, or a computer network (e.g., LAN or WAN). These various types of communication modules may be implemented as a single component (e.g., a single chip), or may be implemented as multiple components (e.g., multiple chips) separate from each other.

According to an embodiment, the memory 260 may store various data used by at least one component (e.g., the transceiver 250 or the processor 270) of the application server 340. For example, the memory 260 may store at least one program for processing and controlling the processor 270 and may store input and/or output data. The memory 260 may store at least one AI model (e.g., machine learning model or deep learning model) and may include a volatile memory or a non-volatile memory.

According to an embodiment, the processor 270 may control the overall operation of the application server 340. The processor 270 may perform an operation or data processing related to control and/or communication of at least one other component of the application server 340. For example, the processor 270 may be electrically connected to the transceiver 250 and the memory 260 and perform the operations of the application server 340 described below.

The processor 270 may include a processing circuit that executes instructions of the program stored in the memory 260. The processor 270 may include at least one of a CPU, an NPU, a GPU, an MPU, an MCU, an AP, a CP, a SoC, an IC sensor hub, a supplementary processor, an ASIC, or an FPGA, and may have a plurality of cores.

The processor 270 may control the operations of the application server 340 by executing the instructions stored in the memory 260. For example, the processor 270 may correspond to a plurality of processors that divide a plurality of operations between processors and collectively perform the operations.

An application server 340, according to an embodiment, may comprise a transceiver 250, memory 260, and at least one processor 270 including processing circuitry. The memory 260 may store instructions that, based on individual or collective execution by the at least one processor 270, cause the application server 340 to transmit a card registration request message for requesting to register a card in an application 350 of an electronic device 201 to an electronic device 201 through the transceiver 250, in response to the card registration request message, receive a card registration response message including first ID information from the electronic device 201 through the transceiver 250, and register the first ID information in association with information about the card.

According to an embodiment, each of the card registration request message and the card registration response message may include an identifier corresponding to the card. The card may include a ticket type card.

According to an embodiment, the memory 260 may store instructions that, based on execution, individually or collectively, by the at least one processor 270, cause the application server 340 to receive a request message for use of the card from the electronic device 201 through the transceiver 250, determine whether second ID information included in the request message corresponds to the first ID information, based on the second ID information corresponding to the first ID information, identify that the ID card authentication is successful, based on a success of the ID card authentication, request card data for use of the card from a partner server 320 through the transceiver 250, and transmit the card data to the electronic device 201 based on receiving the card data from the partner server 320 through the transceiver 250. The first ID information may include a first hash value, and the second ID information includes a second hash value.

According to an embodiment, the memory 260 may store instructions that, based on execution, individually or collectively, by the at least one processor 270, cause the application server 340 to, based on the second ID information not corresponding to the first ID information, identify that the ID card authentication has failed, and based on a failure of the ID card authentication, transmit a notification message indicating that the ID card authentication has failed to the electronic device 201 through the transceiver 250.

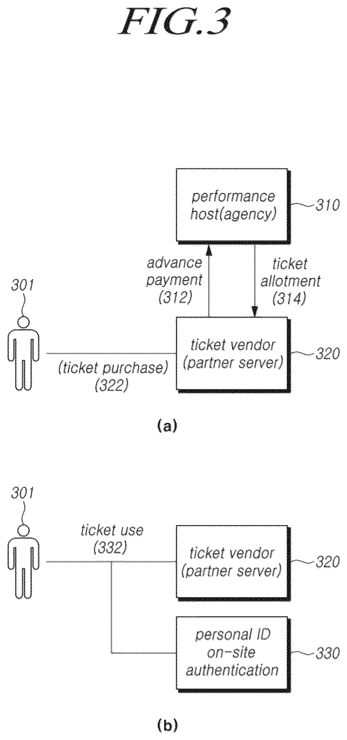

FIG. 3 is a view illustrating an example operation of purchasing a ticket and using a ticket according to one or more embodiment(s).

FIG. 3(a) is a view illustrating a ticket purchase environment, and FIG. 3(b) is a view illustrating a ticket use environment.

Referring to FIG. 3(a), a performance host (or agency) 310 may be an organizer who plans and manages an event or exhibition (e.g., play, concert, show, performance). The ticket vendor 320 (also referred to as partner server 320) may receive a ticket allotment 314 for admission to the event opened by the performance host 310 after making an advance payment 312 to the performance host 310. The ticket vendor 320 may be an online store that sells as many tickets as the number corresponding to the ticket allotment 314. The user 301 may perform a ticket purchase 322 from the ticket vendor 320. For example, the user 301 may purchase a ticket by accessing the website of the ticket vendor 320 through the electronic device 201 or through an application.

According to an embodiment, the user 301 may complete payment for the purchased ticket using a card (e.g., a credit card or a debit card) registered in (e.g., through) an application (e.g., a wallet application) of the electronic device 201. The paid ticket may be registered (e.g., stored) in the application based on the user's selection. Information about the ticket to be registered in the application may be provided from a server included in (e.g., associated with or managed by’ 1) the ticket vendor 320, and the corresponding server may be referred to as a partner server for an application server associated with the application.

Referring to FIG. 3(b), the user 301 may perform identity authentication in order to use the purchased ticket. For example, the user 301 may perform on-site authentication 330 based on the user 301's personal ID card to authenticate that the user 301 is the owner of the purchased ticket.

According to an embodiment, the performance host 310 may compare the user information input for the ticket with the information included in the personal ID card to identify (e.g., determine) whether the ticket is used by the ticket owner. Based on verification (e.g., determination) that the user information input for the ticket and the information included in the personal ID card correspond to (e.g., match) each other, the performance host 310 may determine that the ticket is used by the ticket owner and allow the use of the ticket (or admission through the ticket). Based on the user information input for the ticket and the information included in the personal ID card not matching or corresponding, the performance host 310 determines that the ticket is used by the user who is not the ticket owner and may not allow the use of the ticket (or admission through the ticket). The ticket use method as described above makes it possible to identify the authenticated user or ticket owner, but the process of comparing a physical ID card with a person will likely require much time.

In general, since the time of purchase and the time the ticket is actually used may be different, it is possible that the user information input for the ticket may be unintentionally changed or unauthorized resale or transfer of the ticket may occur through user information change. As a method to prevent this, hereinafter, a method for registering and using a ticket in association with ID information is described.

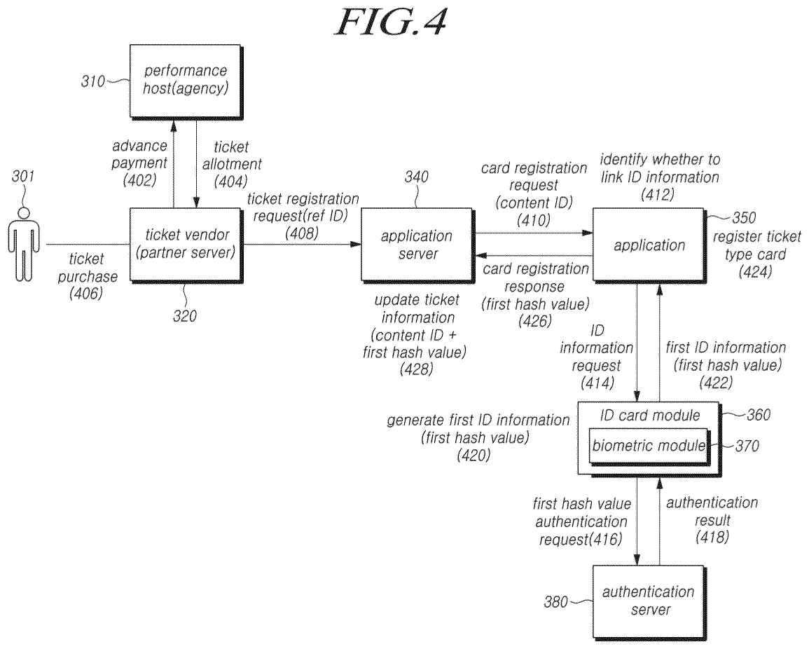

FIG. 4 is a view schematically illustrating an example configuration and operation of a ticket registration system according to one or more embodiment(s).

Referring to FIG. 4, the operation of the ticket registration system, according to an embodiment, may be performed under the assumption that the user 301's ID card (e.g., digital ID or mobile ID) or information related to the ID card is registered or may be used in the electronic device 201, and that the ticket vendor 320 is registered as a partner or partner server in the application server 340. According to an embodiment, the user 301's ID card or the information related to the ID card may be registered in the ID card module 360 and may be used in the application 350 through user authentication or identity authentication.

According to an embodiment, the application server 340 is a server associated with the application 350 and may perform an operation associated with the application 350 or store various information for providing the service of the application 350. The application 350 (also referred to as a “Wallet Server”) is an application included in the electronic device 201 and may support online or offline payment, or may support the registration and use of various types of cards (e.g., ticket type, business card type, boarding pass type, employee ID type, pass type, or coupon type card). The application 350 may be referred to as, e.g., a wallet application, a mobile wallet, an electronic wallet, or an app wallet platform. In the following description, the operation of the application 350 may substantially represent the operation of the electronic device 201 or the processor 240 of the electronic device 201.

In operation 402, according to an embodiment, the ticket vendor 320 may make an advance payment to the performance host 310 to secure a ticket allotment.

In operation 404, according to an embodiment, the ticket vendor 320 may receive a ticket allotment from the performance host 310 based on the advance payment. The ticket allotment is the number of tickets that can be sold by the ticket vendor 320 and may indicate tickets for admission to the performance (e.g., event) opened by the performance host 310. The ticket allotment may be determined based on the contractual relationship between the performance host 310 and the ticket vendor 320.

In operation 406, according to an embodiment, the user 301 may purchase a ticket sold by the ticket vendor 320. For example, the user 301 may purchase a ticket through the ticket purchase platform (e.g., a website or application) of the ticket vendor 320 using the electronic device 201, or purchase a ticket through an offline purchase or on-site purchase. According to an embodiment, the offline purchase or the on-site purchase may be performed through an offline store or may be performed based on communication between the electronic device 201 and an external electronic device corresponding to the ticket vendor 320. For example, the communication between electronic device 201 and external electronic device may include at least one of short-range communication (e.g., NFC, Bluetooth, or WFD communication), direct communication (e.g., peer-to-peer (P2P) communication, or contactless communication (e.g., communication using a QR code). According to an embodiment, the electronic device 201 may purchase a ticket stored in the external electronic device (e.g., a ticket provided from the performance host 310 and stored for sale) through communication with the external electronic device. Based on completion of payment for the ticket by the electronic device 201, the external electronic device may transmit the stored ticket to the electronic device 201 through short-range communication or direct communication, or may provide a code or link for obtaining the ticket, such as a QR code, to the electronic device 201. According to an embodiment, based on a purchased ticket, payment may be performed using a payment card (e.g., a credit card or a debit card) registered in the application 350 of the electronic device 201. However, the payment method is not limited to thereto, and the payments may be made in various ways including wireless deposit (e.g., without a bankbook) or based on different methods of payments supported by each card company.

According to an embodiment, based on the completion of ticket purchase, information about the purchased ticket may be stored in the ticket vendor 320. The ticket vendor 320 may store the information about the ticket purchased by the electronic device 201 in a predetermined format or template.

According to an embodiment, the information about the ticket stored in the ticket vendor 320 may include at least a portion of the ticket information included in Table 1 below.

TABLE 1

| Ticket Information | Description |
|---|---|
| partner ID or template ID | Ticket Vendor (Partner Server) |
| | Identifier |
| ref ID | Ticket Identifier |
| Title | Name of Performance, Event, or |
| | Exhibition |
| Location | Venue of Performance, Event, or |
| | Exhibition |
| Date/Time | Date/Time of Performance, Event, |
| | or Exhibition |

Referring to Table 1, the partner ID or template ID may indicate ID information about the ticket vendor 320. For example, the partner ID may represent the identifier of the ticket vendor 320, and the template ID may represent the identifier of the template of the ticket vendor 320. Since the template may be configured differently for each of a plurality of ticket vendors, it may be possible to identify the ticket vendor 320 among a plurality of ticket vendors based on the template ID. According to an embodiment, the ref ID may indicate the ticket identifier allocated and managed by the ticket vendor 320. For example, the ref ID may be allocated differently for each ticket. According to an embodiment, Title, Location, or Date/Time may be information provided by the performance host 310. Title may represent the name of the performance, event, or exhibition, Location may represent the place of the performance, event, or exhibition, and Date/Time may represent the performance, event, or exhibition schedule.

According to an embodiment, the purchased ticket may be registered in the application 350 based on the user's selection. To this end, the electronic device 201 may display a UI (e.g., button, menu, icon, or graphic object) for registering the purchased ticket in the application 350. For example, the electronic device 201 may display or activate the ‘Add to Wallet’ button along with information about the purchased ticket. According to an embodiment, based on selection of the ‘Add to Wallet’ button by the user's input (e.g., touch input or key input), the electronic device 201 may transmit a message for requesting ticket registration to the ticket vendor 320.

In operation 408, according to an embodiment, the ticket vendor 320 may transmit a ticket registration request message to the application server 340 based on the message of the electronic device 201. According to an embodiment, the ticket registration request message may include at least a portion (e.g., ref ID) of the ticket information as illustrated in Table 1.

According to an embodiment, based on the receipt of the ticket registration request message from the ticket vendor 320, the application server 340 may store or register the ticket information included in the ticket registration request message.

According to an embodiment, the application server 340 may generate a content ID based on the ref ID included in the ticket registration request message. The content ID may be information for identifying a card type (e.g., a ticket, a payment card, a boarding pass, or a coupon type card) registered in the application server 340. Various types of cards may be registered in the application server 340. For example, the types of registered cards may include a payment card type representing means of payment, such as a credit card or debit card, a ticket type representing tickets, such as admission tickets, a boarding pass type representing boarding passes for transportation means (e.g., bus, train, or airplane), or a coupon type representing coupons. The purchased ticket may be registered in the application server 340 as a ticket type card. In case that the card type registered in the application server 340 is the ticket type, the content ID may be stored corresponding to the ref ID.

According to an embodiment, the application server 340 may generate a content ID with a portion that is the same as at least a portion of the ref ID or may generate a content ID in the form of a number (e.g., 4088177717743026112) of a predetermined length (e.g., 19 digits) based on timestamp information corresponding to the time when the ref ID was obtained.

According to an embodiment, based on the ticket information, as shown in Table 1, received from the ticket vendor 320, the application server 340 may store ticket information as shown in Table 2 below.

TABLE 2

| | |
|---|---|
| Ticket Information | Description |

| partner ID or template ID | | | Ticket Vendor (Partner Server) |
|---|---|---|---|
| | | | Identifier |
| | Ticket ID | ref ID | Ticket Vendor's Ticket Identifier |
| | | content ID | Wallet Server's Ticket Identifier |

| | |
|---|---|
| Title | Name of Performance, Event, or |
| | Exhibition |
| Location | Venue of Performance, Event, or |
| | Exhibition |
| Date/Time | Date/Time of Performance, Event, |
| | or Exhibition |

Referring to Table 2, the ticket information stored in the application server 340 may have a form in which the content ID is added to the ticket information in Table 1. For example, the ticket information stored in the application server 340 may include the ref ID and the content ID indicated for the same ticket as two types of ticket identifiers (Ticket IDs). According to an embodiment, in case that the content ID is set to be the same as the ref ID, the content ID may not be included, and ticket information as shown in Table 1 may be stored in the application server 340.

According to an embodiment, the content ID may be used to indicate the ticket in communication between the application server 340 and the application 350, and the content ID and the ref ID may be used to indicate the ticket in communication between the application server 340 and the ticket vendor 320.

In operation 410, according to an embodiment, the application server 340 may transmit a card registration request message to the application 350. For example, the card registration request message may indicate a message for requesting that the ticket type card corresponding to the purchased ticket be registered in the application 350. According to an embodiment, the application 350 may identify the card to be registered in the application 350 based on the reception of the card registration request message. According to an embodiment, the application 350 may receive the card registration request message from the application server 340, identify information about the card to be registered based on the card registration request message, and display the card to be registered based on the identified information on the display 220.

According to an embodiment, the application 350 may determine whether the type of card to be registered is a type requiring ID card linkage (e.g., connection). For example, the application 350 may identify the card to be registered as a type (e.g., ticket type) requiring ID card linkage based on the inclusion of at least a portion of the ticket information (e.g., content ID) as shown in Table 2 in the card registration request message. In operation 412, according to an embodiment, the application 350 may perform a separate provisioning operation for linking the card to be registered and ID information based on the card to be registered being identified as a type requiring ID card linkage. The provisioning operation may include an operation for identifying whether to link the ID information to the card to be registered. According to an embodiment, the application 350 may display a first UI for ID card linkage on the display 220 based on determining that the type of card to be registered is the type requiring ID card linkage. For example, in case of determining that the type of card to be registered is the ticket type requiring ID card linkage, the application 350 may display a prompt message such as “Do you want to link ID information to the ticket?” as the first UI for ID card linkage on at least a portion of the execution screen or in a popup window. The application 350 may obtain the first ID information from the ID card module 360 based on receiving an input based on the first UI (e.g., the prompt message or an input instructing to link the ID information to the ticket). According to an embodiment, the ID card module 360 may include, e.g., an SDK related to ID card verification and may obtain and store information related to the ID card from the external authentication server 380. According to an embodiment, the application 350 may perform user authentication (e.g., biometric authentication such as fingerprint, iris, or face authentication, or authentication through password or pattern input) to access the ID card module 360. According to an embodiment, the user authentication may be performed through a separate authentication module (e.g., a biometric authentication module, a password authentication module, or a pattern authentication module) linked to the ID card module 360. The application 350 may access the ID card module 360 operated in a secure area such as the TEE based on the success of user authentication. According to an embodiment, the application 350 may perform operation 414 based on the accessibility to the ID card module 360.

In operation 414, according to an embodiment, the application 350 may request the first ID information from the ID card module 360. According to an embodiment, the ID card module 360 is a module included in the application 350 or operated in conjunction with the application 350, and the ID card module 360 may be executed in the secure area. The secure area may represent a secure space for protecting data or information from an external attack and processing it safely. For example, the secure area may include a TEE distinguished from an environment in which the application 350 is executed.

According to an embodiment, the ID card module 360 may generate a first hash value (hereinafter, referred to as a “hash value”) based on the user 301's ID card in response to the request for the first ID information. For example, the ID card module 360 may generate the first hash value based on information (e.g., user face information or user ID information) included in the user 301's ID card.

In operation 416, according to an embodiment, the ID card module 360 may request authentication for the first hash value from the authentication server 380 (e.g., the external authentication server or the authentication server on the network).

In operation 418, according to an embodiment, the authentication server 380 may provide an authentication result based on whether the first hash value is associated with or corresponds to the user 301's ID card (or the information included in the ID card) stored in the authentication server 380 to the ID card module 360, in response to the request of the ID card module 360. For example, in case that the first hash value is associated with or corresponds to the user 301's ID card stored in the authentication server 380, the authentication server 380 may transmit an authentication success message to the ID card module 360. For example, in case that the first hash value is not associated with or does not correspond to the user 301's ID card stored in the authentication server 380, the authentication server 380 may transmit an authentication failure message to the ID card module 360.

In operation 420, according to an embodiment, the ID card module 360 may generate first ID information based on receiving the authentication success message as an authentication result from the authentication server 380. According to an embodiment, the ID card module 360 may generate first ID information based on the authenticated first hash value.

In operation 422, according to an embodiment, the ID card module 360 may provide the generated first ID information to the application 350.

In operation 424, according to an embodiment, based on obtaining the first ID information, the application 350 may register the card (e.g., the ticket type card), to be registered in association with the first ID information, in the application 350.

In operation 426, according to an embodiment, based on the registration of the card to be registered, the application 350 may transmit a card registration response message to the application server 340. According to an embodiment, based on the card to be registered being registered in association with the first ID information, the application 350 may transmit the first ID information (e.g., the first hash value) to the application server 340 as ID information corresponding to the content ID received in operation 410.

In operation 428, according to an embodiment, based on the reception of the card registration response message, the application server 340 may identify (e.g., determine) that the ticket type card has been registered in association with the first ID information in the application 350 and update the ticket information in Table 2. For example, the application server 340 may add the first hash value to the ticket information as the ID information of the ticket user (or ticket buyer) (e.g., the user 301) as shown in Table 3 below. According to an embodiment, the first hash value may represent the first hash value included in the first ID information and may be included in the ticket information as the attribute value of the content ID or information associated with the content ID.

TABLE 3

| | |
|---|---|
| Ticket Information | Description |

| partner ID or template ID | | | Ticket Vendor (Partner Server) |
|---|---|---|---|
| | | | Identifier |
| | Ticket | ref ID | Ticket Vendor's Ticket Identifier |
| | ID | content ID | Wallet Server's Ticket Identifier |
| | | first hash value | First ID Information |

| | |
|---|---|
| Title | Name of Performance, Event, or |
| | Exhibition |
| Location | Venue of Performance, Event, or |
| | Exhibition |
| Date/Time | Date/Time of Performance, Event, |
| | or Exhibition |

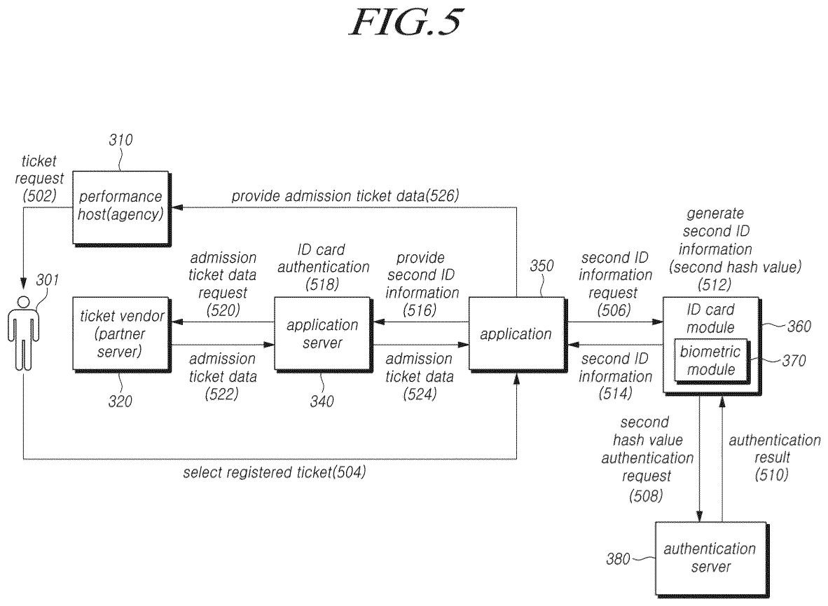

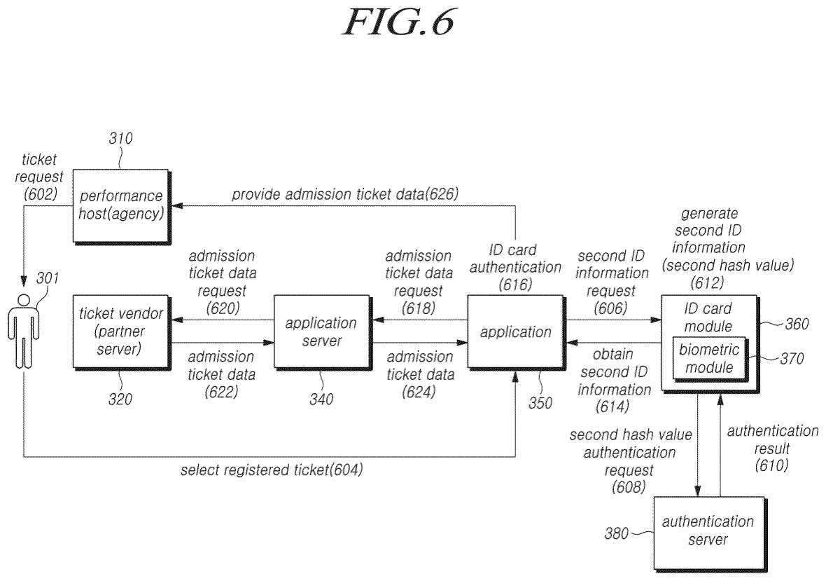

According to an embodiment, based on completion of the operations illustrated in FIG. 4, a ticket use operation as illustrated in FIG. 5 or 6 may be performed.

FIG. 5 is a view schematically illustrating an example configuration and operation of a ticket use system according to one or more embodiment(s).

Referring to FIG. 5, in operation 502, according to an embodiment, the performance host 310 may request a ticket from the user 301. The performance host 310 may compare the ticket and the ID card in person at the event and permit admission based on the comparison result. The performance host 310 may request the ticket and the ID from the user 301 or may request admission ticket data issued to an authenticated user (or the owner of the ticket).

In operation 504, according to an embodiment, the user 301 may select a ticket registered in the application 350 of the electronic device 201. According to an embodiment, the ticket registered in the application 350 may correspond to the ticket type card registered in operation 424 of FIG. 4. According to an embodiment, the user 301 may execute the application 350 in the electronic device 201 to select any one of the ticket type cards registered in the application 350 or may perform a predetermined operation for quick ticket selection. For example, the predetermined operation may include swiping in a predetermined direction (e.g., a direction to an upper end of the display 220) from a predetermined position (e.g., a lower end) of the screen (e.g., the home screen) of the electronic device 201. According to an embodiment, a quick execution screen (or a quick access (QA) screen) of the application 350 may be displayed (e.g., executed) by a swipe. The ticket type card may be displayed on the quick execution screen, and the user 301 may perform a predetermined input (e.g., a touch input on the displayed card) to select the displayed card. According to an embodiment, a ticket detail screen may be displayed based on the selection of the ticket type card by the user. According to an embodiment, the ticket detail screen may be a screen on which ticket information (e.g., performance name, place, or schedule information) is displayed and may be used to obtain ticket data.

In operation 506, according to an embodiment, the application 350 may request the second ID information from the ID card module 360 driven in the secure area (e.g., TEE) to obtain admission ticket data corresponding to the ticket based on the display of the ticket detail screen. According to an embodiment, the application 350 may perform user authentication (e.g., biometric authentication such as fingerprint, iris, or face authentication, or authentication through password or pattern input) for accessing the ID card module 360 before requesting the second ID information. Based on the success of user authentication, the application 350 may access the ID card module 360 and request the second ID information.

According to an embodiment, the ID card module 360 may generate a second hash value based on the user 301's ID card based on the second ID information request of the application 350. For example, the ID card module 360 may generate the second hash value based on information (e.g., user face information or user ID information) included in the user 301's ID card.

In operation 508, according to an embodiment, the ID card module 360 may request authentication for the second hash value from the authentication server 380.

In operation 510, according to an embodiment, the authentication server 380 may provide an authentication result based on whether the second hash value is associated with or corresponds to the user 301's ID card (or the information included in the ID card) stored in the authentication server 380 to the ID card module 360, in response to the request of the ID card module 360. For example, in case that the second hash value is associated with or corresponds to the user 301's ID card stored in the authentication server 380, the authentication server 380 may transmit an authentication success message to the ID card module 360. For example, in case that the second hash value is not associated with or does not correspond to the user 301's ID card stored in the authentication server 380, the authentication server 380 may transmit an authentication failure message to the ID card module 360.

In operation 512, according to an embodiment, the ID card module 360 may generate second ID information based on receiving the authentication success message as an authentication result from the authentication server 380. According to an embodiment, the ID card module 360 may generate second ID information based on the authenticated second hash value.

In operation 514, according to an embodiment, the ID card module 360 may provide the generated second ID information to the application 350.

In operation 516, according to an embodiment, the application 350 may provide the second ID information provided from the ID card module 360 to the application server 340. According to an embodiment, the application 350 may transmit information (e.g., content ID) about the ticket selected by the user and second ID information (e.g., the second hash value) of the user 301 to the application server 340.

In operation 518, according to an embodiment, the application server 340 may perform ID card authentication for ticket user authentication based on the information (e.g., content ID and second hash value) received from the application 350. According to an embodiment, the application server 340 may identify the ticket based on the content ID and compare the first ID information (e.g., the first hash value) stored at the registration time of the identified ticket with the second ID information (e.g., the second hash value) received in operation 516. According to an embodiment, in case that the first hash value and the second hash value do not correspond, the application server 340 may transmit a message indicating that ID card authentication has failed to the application 350. The application 350 may output a notification message indicating that ID card authentication has failed based on the message of the application server 340. According to an embodiment, in case that the first hash value and the second hash value correspond, in operation 520, the application server 340 may transmit a request message for requesting admission ticket data to the second server (e.g., the partner server, the ticket vendor 320). According to an embodiment, the request message may include the ref ID corresponding to the content ID.

In operation 522, according to an embodiment, the ticket vendor 320 may transmit admission ticket data to the application server 340 in response to the request message. According to an embodiment, the ticket vendor 320 may identify the ticket based on the ref ID and generate admission ticket data corresponding to the identified ticket. For example, the admission ticket data may include a barcode, a QR code, or other types of admission authentication data. The barcode or QR code may be a dynamic barcode or dynamic QR code that is valid for a predetermined time. According to an embodiment, the ticket vendor 320 may transmit the admission ticket data to the application server 340 together with the ref ID.

According to an embodiment, the application server 340 may receive the admission ticket data from the ticket vendor 320. According to an embodiment, the application server 340 may identify the received admission ticket data as admission ticket data associated with the content ID corresponding to the ref ID.

In operation 524, according to an embodiment, the application server 340 may transmit the identified admission ticket data to the application 350. According to an embodiment, the ticket vendor 320 may transmit the admission ticket data to the application 350 together with the content ID.

In operation 526, according to an embodiment, the application 350 may provide the admission ticket data received from the application server 340 to the performance host 310 based on the user's selection. For example, in case that the admission ticket data is a barcode or QR code, the admission ticket data may be scanned by the performance host 310 and transmitted to the performance host 310.

According to an embodiment, the admission ticket data may indicate that the authentication operation has been completed and may be issued to the authenticated user and used without providing an ID card or additional authentication. Therefore, since admission may be permitted after scanning of the admission ticket data, the performance host 310 may simplify the admission process and the user 301 may have the convenience of quicker admission to the venue.

FIG. 6 is a view schematically illustrating an example configuration and operation of a ticket use system according to one or more embodiment(s).

Operations 602 to 614 of FIG. 6 correspond to operations 502 to 514 of FIG. 5, and thus detailed descriptions thereof are omitted. Unlike in FIG. 5, in FIG. 6, an ID card authentication operation may be performed by the application 350 instead of the application server 340.

Referring to FIG. 6, in operation 616, according to an embodiment, the application 350 may perform ID card authentication. According to an embodiment, the application 350 may identify the content ID corresponding to the ticket selected by the user in operation 604, and compare the first ID information (e.g., the first hash value) stored at the time of registration with the second ID information (e.g., the second hash value) obtained from the ID card module 360 in operation 614. For example, in case that the first hash value and the second hash value do not correspond, the application 350 may output a notification message indicating that ID card authentication has failed. In case that the first hash value and the second hash value correspond to each other, the application 350 may transmit a first request message for requesting admission ticket data to the application server 340 in operation 618. According to an embodiment, the first request message may include the content ID.

In operation 620, according to an embodiment, the application server 340 may receive the first request message from the application 350 and transmit a second request message for requesting admission ticket data to the ticket vendor 320 based on the received first request message. According to an embodiment, the application server 340 may identify the ref ID corresponding to the content ID included in the first request message and transmit a second request message including the identified ref ID to the ticket vendor 320.

In operation 622, according to an embodiment, the ticket vendor 320 may transmit the admission ticket data to the application server 340 in response to the second request message. According to an embodiment, the ticket vendor 320 may identify the ticket based on the ref ID and generate admission ticket data corresponding to the identified ticket. For example, the admission ticket data may include a barcode, a QR code, or other types of admission authentication data. A barcode or QR code may be a dynamic barcode or dynamic QR code that is valid for a predetermined time. According to an embodiment, the ticket vendor 320 may transmit the admission ticket data to the application server 340 together with the ref ID. The application server 340 may receive the admission ticket data from the ticket vendor 320. According to an embodiment, the application server 340 may identify the received admission ticket data as admission ticket data associated with the content ID corresponding to the ref ID.

In operation 624, according to an embodiment, the application server 340 may transmit the identified admission ticket data to the application 350. According to an embodiment, the ticket vendor 320 may transmit the admission ticket data to the application 350 together with the content ID.

In operation 626, according to an embodiment, the application 350 may provide the admission ticket data received from the application server 340 to the performance host 310 based on the user's selection. For example, in case that the admission ticket data is a barcode or QR code, the admission ticket data may be scanned by the performance host 310 and transmitted to the performance host 310. According to an embodiment, the admission ticket data is issued to the authenticated user and may be used without providing an ID card or additional authentication. In case that the admission ticket data is used, performing on-site authentication based on the user 301's personal ID card and the purchased ticket for user authentication on the purchased ticket may be omitted. Therefore, the admission to the performance may be performed more accurately and quickly.

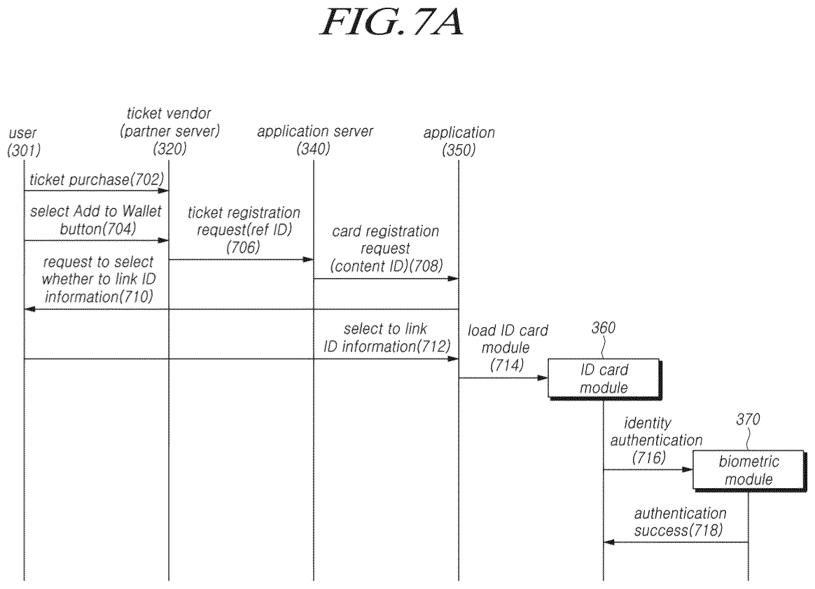

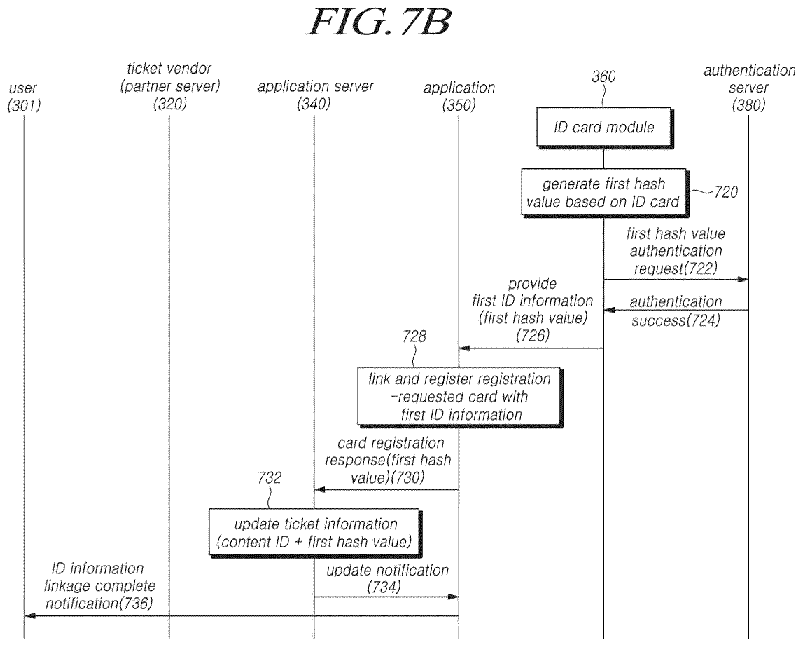

Hereinafter, a ticket registration operation and a ticket use operation are described in detail with reference to FIGS. 7A to 9B. According to an embodiment, the operation of the application 350 illustrated in FIGS. 7A to 9B may be understood as an operation performed by the processor 240 of the electronic device 201 or the electronic device 201. The operations illustrated in each of FIGS. 7A to 9B may be performed in various orders without being limited to the illustrated order. According to an embodiment, at least some of the operations illustrated in each of FIGS. 7A to 9B may be omitted, or more operations may be performed than those illustrated in each of FIGS. 7A to 9B.

FIG. 7A is a flowchart illustrating an example operation of accessing an ID card module to register a ticket type card according to one or more embodiment(s).

Referring to FIG. 7A, in operation 702, according to an embodiment, the user 301 may purchase a ticket. According to an embodiment, the user 301 may purchase a ticket through the ticket purchase platform (e.g., the online website or application) of the ticket vendor 320, an offline store, on-site purchase (e.g., short-range communication, direct communication, or QR code-based communication with the external electronic device corresponding to the ticket vendor 320) using the electronic device 201. The electronic device 201 may display an input means for adding the ticket to the application 350 (e.g., a wallet application, a mobile wallet, or an electronic wallet) based on the completion of the ticket purchase. For example, the electronic device 201 may display or activate the ‘Add to Wallet’ button as an input means on the screen (e.g., ticket purchase completion screen) of the electronic device 201.

In operation 704, according to an embodiment, the user 301 may select the ‘Add to Wallet’ button based on a touch input or a key input. The electronic device 201 may transmit a message for requesting registration of the purchased ticket to the ticket vendor 320 based on the selection of the ‘Add to Wallet’ button. According to an embodiment, the ticket vendor 320 may trigger an operation of adding information or data of the ticket to the application server 340 while the function associated with the ‘Add to Wallet’ button is integrated. The input means for adding the ticket to the application 350 is not limited to the embodiment of the button, and an operation of registering the ticket in the application 350 from the user may be performed through other input means of multi-modal input (e.g., voice, gesture, etc.).

In operation 706, according to an embodiment, the ticket vendor 320 may transmit the ticket registration request message to the application server 340 based on the selection of the ‘Add to Wallet’ button. According to an embodiment, the ticket registration request message may include information about the ticket purchased by the user 301. For example, the first ticket registration request message may include at least a portion (e.g., the ref ID predetermined by the ticket vendor 320) of the ticket information stored in the ticket vendor 320, as shown in Table 1.

According to an embodiment, the application server 340 may receive the ticket registration request message from the ticket vendor 320 and store or register the ticket information included in the ticket registration request message. According to an embodiment, the application server 340 may generate the content ID based on the ref ID included in the ticket registration request message and add the generated content ID to the ticket information. The content ID is ID information allocated to the ticket by the application server 340 and may be used to manage the ticket. According to an embodiment, the ticket may be registered as the ticket type card in the application server 340, and the content ID may be used to identify or indicate the ticket type card. In the application server 340, the content ID may be stored corresponding to the ref ID, which is the ticket identifier of the ticket vendor 320.

In operation 708, according to an embodiment, the application server 340 may transmit a card registration request message to the application 350. According to an embodiment, the card registration request message may represent a message for requesting registration of the ticket type card corresponding to the ticket to be registered in the application 350. According to an embodiment, the card registration request message may include ticket information, and the ticket information may include at least a portion (e.g., content ID) of the ticket information as shown in Table 2.

According to an embodiment, the application 350 may receive the card registration request message from the application server 340 and identify the card to be registered in the application 350. According to an embodiment, the application 350 may receive the card registration request message from the application server 340 and identify information about the card to be registered based on the card registration request message. The application 350 may display the card to be registered on the display 220 based on the identified information.

According to an embodiment, the application 350 may determine whether the type of card to be registered is a type requiring ID card linkage (e.g., connection). For example, the application 350 may identify the card to be registered as the ticket type card based on the inclusion of the ticket information in the card registration request message and determine the card to be registered as the type requiring ID card linkage based on the card to be registered being the ticket type card.

According to an embodiment, the application 350 may receive the user's ID for performing ID card linkage based on determining that the type of card to be registered is the type requiring ID card linkage. For example, the application 350 may perform operations 710 and 712 to receive the user's confirmation, which may be omitted. According to an embodiment, the application 350 may directly perform the operation (e.g., operation 714 and its subsequent operations) for ID card linkage without the user's confirmation based on determining that the type of card to be registered is the type requiring ID card linkage.

In operation 710, according to an embodiment, the application 350 may request the user 301 to select whether to link the ID information based on determining that the type of card to be registered is the type requiring ID card linkage. For example, the application 350 may display a message such as a first UI (e.g., “Do you want to link the ID card to the ticket?” and “yes” and “no” buttons) for ID card linkage on the display 220 (e.g., at least portion of the execution screen or a pop-up window) based on determining that the type of card to be registered is the type requiring ID card linkage.

In operation 712, according to an embodiment, the application 350 may receive an input (e.g., an input based on the “yes” button) of the user 301 who selects to link the ID information to the ticket.

In operation 714, according to an embodiment, the application 350 may load the ID card module 360 based on the input of the user 301. According to an embodiment, the application 350 may load the ID card module 360 to obtain first ID information of the user 301 to be linked to the ticket type card. According to an embodiment, the ID card module 360 is a module included in the application 350 or operated in conjunction with the application 350 and may be executed in the secure area. The secure area may represent a secure space for protecting data or information from an external attack and for safe processing. For example, the secure area may include a TEE distinguished from an environment in which the application 350 is executed.

According to an embodiment, the ID card module 360 may include, e.g., an SDK related to ID card verification and may obtain and store information related to the ID card from the external authentication server 380. According to an embodiment, the ID card module 360 may provide first ID information based on the information related to the user 301's ID card, but access may be limited. For example, the ID card module 360 may be accessed through user authentication (e.g., identity authentication of the user 301) and may be linked to at least one authentication module (e.g., the biometric module 370) for user authentication. As described below, the user authentication may be performed through biometric authentication, but is not limited thereto, and other types of authentication, such as password or pattern input, may be performed.

In operation 716, according to an embodiment, the ID card module 360 may request the biometric module 370 to perform an identity authentication operation associated with the user 301 of the application 350 based on being loaded by the application 350. The biometric module 370 may perform an authentication operation for determining whether access to the ID card module 360 is performed by the permitted user. For example, the biometric module 370 may recognize the fingerprint, iris, or face of the user 301, and perform identity authentication by comparing the recognition result with pre-stored information.

According to an embodiment, in case that the identity authentication fails, the biometric module 370 may provide information indicating that identity authentication has failed to the ID card module 360. In this case, the ID card module 360 may provide the application 350 with an indication that the first ID information may not be provided due to the failure of identity authentication, and the application 350 may output a message indicating that the first ID information may not be linked to the ticket type card on the screen.

According to an embodiment, in case that the identity authentication is successful, in operation 718, the biometric module 370 may provide the information indicating that identity authentication is successful to the ID card module 360. According to an embodiment, the ID card module 360 may allow access for the user 301 of the application 350 based on the success of the identity authentication. According to an embodiment, the ID card module 360 may receive a request message for requesting the first ID information of the user 301 from the application 350 based on the access being allowed.

According to an embodiment, operation 720 of FIG. 7B may be performed based on operation 718 of FIG. 7A.

FIG. 7B is a flowchart illustrating an example operation of registering a ticket type card according to one or more embodiment(s). Referring to FIG. 7B, in operation 720, according to an embodiment, the ID card module 360 may generate a first hash value based on the user 301's ID card. For example, the ID card module 360 may generate the first hash value based on the information (e.g., user face information or user ID information) included in the user 301's ID card in response to receiving a request message for requesting the user 301's first ID information from the application 350.

In operation 722, according to an embodiment, the ID card module 360 may request authentication for the first hash value from the authentication server 380.

In operation 724, according to an embodiment, the authentication server 380 may provide an authentication result based on whether the first hash value is associated with or corresponds to the user 301's ID card (or the information included in the ID card) stored in the authentication server 380 to the ID card module 360, in response to the request of the ID card module 360. For example, in case that the first hash value is associated with or corresponds to the user 301's ID card stored in the authentication server 380, the authentication server 380 may transmit an authentication success message to the ID card module 360.

In operation 726, according to an embodiment, the ID card module 360 may provide the first ID information to the application 350 based on the success of the authentication of the first hash value. According to an embodiment, the first ID information is data different from the original data of the ID card and may include, e.g., the first hash value authenticated by the authentication server 380. Since the first hash value represents a general data value rather than a value indicating the original data included in the ID card, direct disclosure of personal information may be prevented, and it may be stored in the application server 340. Since the first hash value may be generated based on data or information (e.g., user face information or user ID information) included in the ID card, the data or information included in the ID card may be maintained at the same value as long as it is not changed.

In operation 728, according to an embodiment, the application 350 may register the card in the application 350 by linking the card to the first ID information based on obtaining the first ID information.

In operation 730, according to an embodiment, the application 350 may transmit a card registration response message to the application server 340 based on the registration of the card. According to an embodiment, the card registration response message may include the first hash value as the attribute value of the content ID received in operation 708 of FIG. 7A or as first ID information corresponding to the content ID.

In operation 732, according to an embodiment, the application server 340 may update ticket information based on the card registration response message received from the application 350. According to an embodiment, the application server 340 may update the ticket information so that the first hash value is included corresponding to the content ID.

In operation 734, according to an embodiment, the application server 340 may transmit a ticket information update notification message to the application 350 based on the update of the ticket information. The ticket information update notification message may indicate that the first hash value has been registered in the application server 340.

In operation 736, according to an embodiment, the application 350 may perform an operation for notifying the user 301 of the ID information linkage completion notification message based on the ticket information update notification message. According to an embodiment, the application 350 may output a message indicating that the first ID information is linked to the ticket (or ticket type card) on the execution screen or pop-up window.

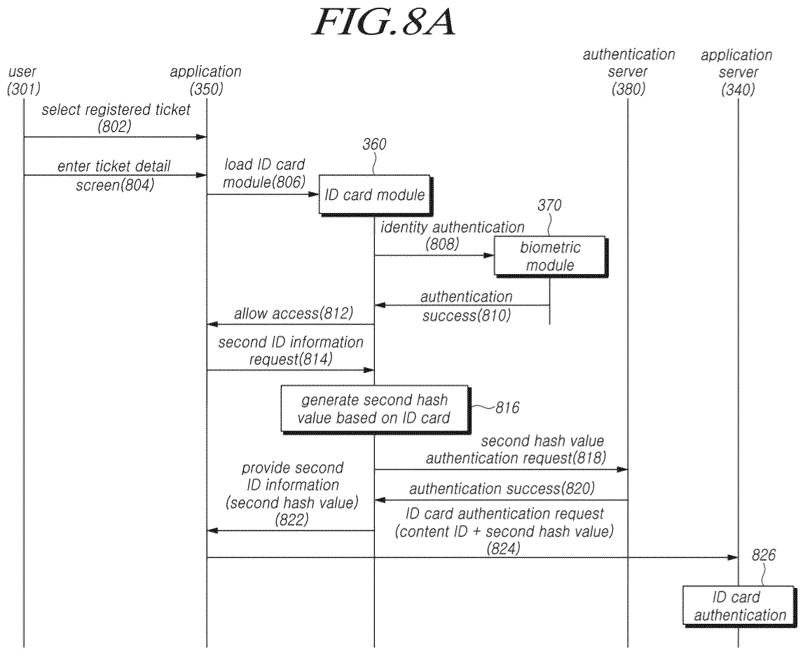

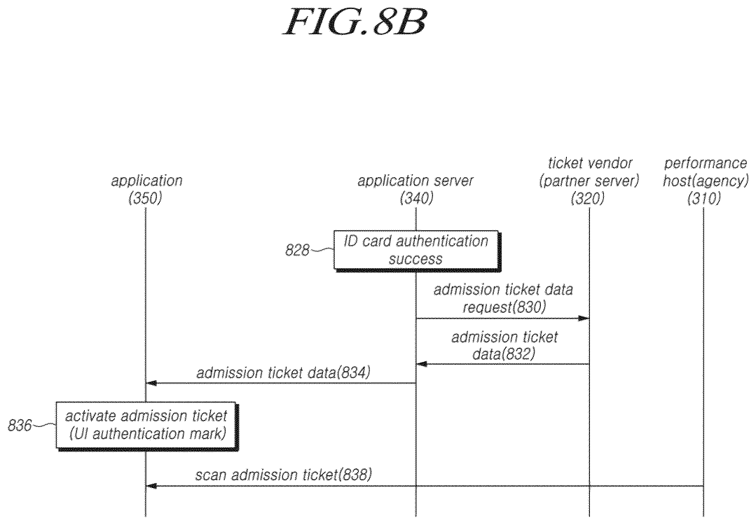

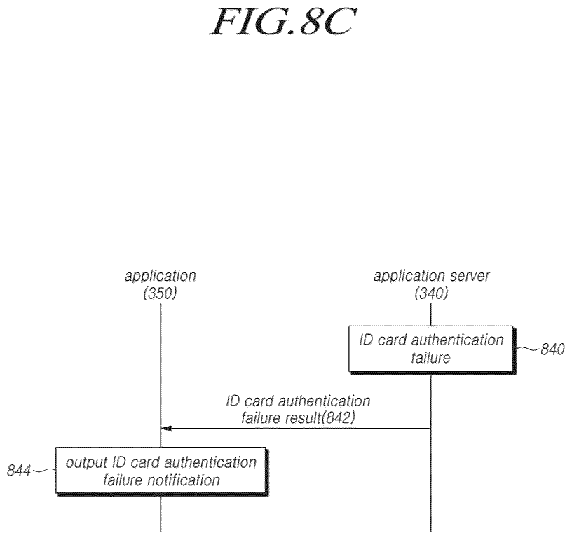

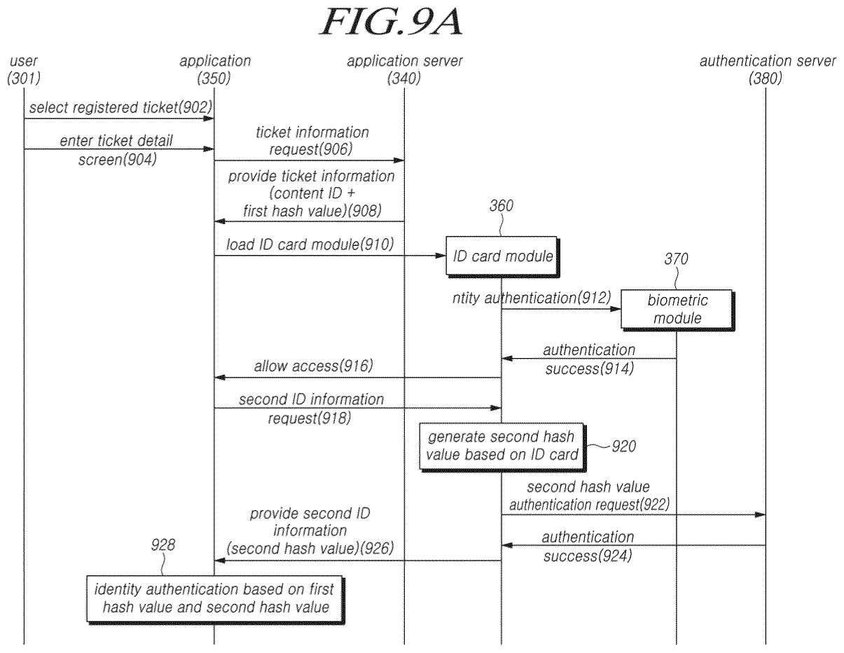

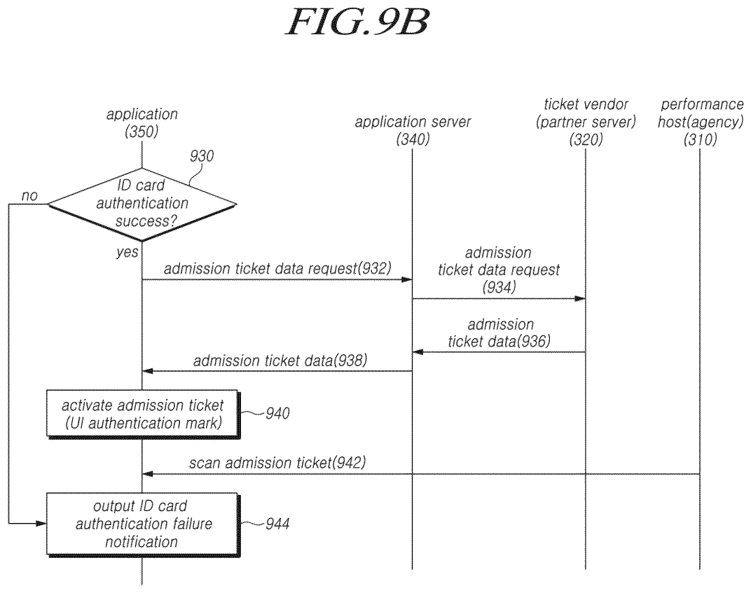

According to an embodiment, based on completion of the ticket registration operation in reference to the operations illustrated in FIGS. 7A and 7B, the ticket use operation as illustrated in FIGS. 8A to 8C, or 9A to 9C may be performed (e.g., executed). According to an embodiment, FIGS. 8A to 8C may represent a ticket use operation based on ID card authentication of the application server 340, and FIGS. 9A to 9C may represent a ticket use operation based on ID card authentication of the application 350.

FIG. 8A is a flowchart illustrating an example operation of performing ID card authentication in an application server for ticket use according to one or more embodiment(s).

Referring to FIG. 8A, in operation 802, according to an embodiment, the user 301 may select a registered ticket. According to an embodiment, the user 301 may swipe up the screen of the electronic device 201 to execute the application 350 and select the ticket type card displayed on the quick execution screen (or QA screen) of the application 350 as a registered ticket.

In operation 804, according to an embodiment, the user 301 may enter the detailed screen of the selected ticket through a predetermined input (e.g., a touch input on the ticket type card) for the selected ticket on the quick execution screen. The detailed screen of the selected ticket may be entered to obtain admission ticket data (e.g., QR code or barcode).

In operation 806, according to an embodiment, the application 350 may load (e.g., execute) the ID card module 360. According to an embodiment, the ID card module 360 may include, e.g., an SDK related to ID card verification and may obtain and store information related to the ID card from the external authentication server 380. According to an embodiment, the application 350 may load the ID card module to use the information related to the ID card.

In operation 808, according to an embodiment, the ID card module 360 is a module operated in the secure area (e.g., TEE) and may request an identity authentication operation from the biometric module 370 to allow access by the authenticated user. The biometric recognition module 370 may perform an identity authentication operation based on biometric authentication based on a request of the ID card module 360. For example, the biometric module 370 may recognize the fingerprint, iris, or face of the user 301 and perform (e.g., execute) identity authentication by comparing the recognition result with pre-stored the information.

In operation 810, according to an embodiment, the biometric module 370 may provide information indicating that the identity authentication is successful to the ID card module 360 based on the success of the identity authentication. The biometric module 370 may provide information indicating that the identity authentication has failed to the ID card module 360 based on the failure of the identity authentication.

In operation 812, according to an embodiment, the ID card module 360 may allow access to the ID card module 360 for the application 350 based on receiving the information indicating that identity authentication has been successful. According to an embodiment, the ID card module 360 may not allow access to the ID card module 360 for the application 350 based on receiving the information indicating that identity authentication has failed. In case that access to the ID card module 360 is not allowed, the application 350 may not obtain the second ID information from the ID card module 360, and thus the ticket may not be used.

In operation 814, according to an embodiment, the application 350 may request the second ID information from the ID card module 360 based on the access being allowed of the ID card module 360. According to an embodiment, the second ID information may be ID information associated with the user 301 who is the ticket user.

In operation 816, according to an embodiment, the ID card module 360 may generate the second hash value based on the user 301's ID card (or ID card-related information) registered in the ID card module 360 based on the request of the application 350. For example, the ID card module 360 may generate the second hash value based on the information (e.g., user face information or user ID information) included in the user 301's ID card.

In operation 818, according to an embodiment, the ID card module 360 may request authentication for the second hash value from the authentication server 380.

In operation 820, according to an embodiment, the authentication server 380 may transmit an authentication success message to the ID card module 360 in response to a request of the ID card module 360.

According to an embodiment, the authentication server 380 may determine whether the second hash value is associated with or corresponds to the user 301's ID card (or the information included in the ID card) stored in the authentication server 380, based on the request of the ID card module 360. In case that the second hash value is associated with or corresponds to the user 301's ID card stored in the authentication server 380, the authentication server 380 may transmit an authentication success message to the ID card module 360. In case that the second hash value is not associated with or does not correspond to the user 301's ID card stored in the authentication server 380, the authentication server 380 may transmit an authentication failure message to the ID card module 360.

In operation 822, according to an embodiment, the ID card module 360 may transmit second ID information including the second hash value to the application 350 based on receiving the authentication success message from the authentication server 380. According to an embodiment, based on receiving the authentication failure message from the authentication server 380, the ID card module 360 may transmit a message indicating that the second ID information cannot be provided to the application 350 because the second hash value for which authentication has failed may not be used. In this case, the application 350 may not obtain the second ID information from the ID card module 360, and thus the ticket cannot be used.

In operation 824, according to an embodiment, the application 350 may request ID card authentication from the application server 340 based on receiving the second ID information. According to an embodiment, the application 350 may transmit the second ID information (e.g., the second hash value) obtained in operation 822 to the application server 340 as information based on the content ID to compare with the first ID information (e.g., the first hash value) registered at the time of ticket registration. For example, the application 350 may request ID card authentication by transferring the content ID and the second hash value to the application server 340.

In operation 826, according to an embodiment, the application server 340 may perform ID card authentication based on a request of the application 350. According to an embodiment, the application server 340 may compare the first hash value registered as the first ID information with the second hash value received in operation 824 corresponding to the content ID and perform ID card authentication based on the comparison result.

According to an embodiment, in case that the first hash value and the second hash value correspond to each other, the application server 340 may determine that ID card authentication is successful and perform the operations illustrated in FIG. 8B.

According to an embodiment, in case that the first hash value and the second hash value do not correspond, the application server 340 may determine that ID card authentication has failed and perform the operations illustrated in FIG. 8C.

FIG. 8B is a flowchart illustrating an example operation based on a successful ID card authentication in an application server according to an embodiment.

Referring to FIG. 8B, in operation 818, according to an embodiment, the application server 340 may identify that ID card authentication is successful. Operation 828 may be an operation performed following operation 826 of FIG. 8A. According to an embodiment, the application server 340 may identify that ID card authentication has been successful based on the ID card authentication result of operation 826.

In operation 830, according to an embodiment, the application server 340 may transmit a request message for requesting admission ticket data to the ticket vendor 320 based on the success of the ID card authentication. According to an embodiment, the request message may include the ref ID corresponding to the content ID of the ticket.

In operation 832, according to an embodiment, the ticket vendor 320 may transmit the admission ticket data to the application server 340 in response to the request message. According to an embodiment, the ticket vendor 320 may identify the ticket based on the ref ID and generate admission ticket data corresponding to the identified ticket. For example, the admission ticket data may include a barcode or QR code or may include a dynamic barcode or dynamic QR code that is valid for a predetermined time to enhance security. According to an embodiment, the ticket vendor 320 may transmit the admission ticket data to the application server 340 together with the ref ID.

In operation 834, according to an embodiment, the application server 340 may receive the admission ticket data from the ticket vendor 320. According to an embodiment, the application server 340 may identify the content ID corresponding to the ref ID and identify the received admission ticket data as admission ticket data of the ticket corresponding to the content ID.

According to an embodiment in operation 836, the application 350 may activate the admission ticket based on the admission ticket data. According to an embodiment, the operation of activating the admission ticket may include at least one of an operation of displaying the admission ticket data on the screen, an operation of enlarging or displaying the admission ticket data brightly, or an operation of adding an authentication mark to the admission ticket data and displaying it. For example, the authentication mark may include a UI authentication mark indicating that the ticket user's ID card authentication has been completed or indicating that the ticket user is the authenticated user.

In operation 838, according to an embodiment, the performance host 310 may enable selection and admission of a valid audience without a separate ID authentication procedure by scanning the admission ticket for which ID card authentication has been completed.

FIG. 8C is a flowchart illustrating an example operation based on a failed ID card authentication in a wallet server according to one or more embodiment(s).

Referring to FIG. 8C, in operation 840, according to an embodiment, the application server 340 may identify that ID card authentication has failed. Operation 840 may be an operation performed following operation 826 of FIG. 8A, and ID that ID card authentication has failed based on the ID card authentication result of operation 826.

In operation 842, according to an embodiment, the application server 340 may transmit the ID card authentication failure result to the application 350.

In operation 844, according to an embodiment, the application 350 may output a notification message indicating that ID card authentication has failed to the display 220 based on the ID card authentication failure result. Based on the failure of the ID card authentication, the ticket registered in the application 350 may not be used. As described above, since the ticket registered in the application 350 may be used by the authenticated user, theft or illegal resale of the ticket may be prevented.

The operations of FIGS. 8A to 8C are not limited to the embodiment of a ticket (or an admission ticket) and may be extended to various contents requiring ID card authentication. For example, the ticket may be replaced with a boarding pass, an admission ticket, an employee ID, or a receipt, and the operations of FIGS. 8A to 8C may be performed for ID card authentication for various contents.

FIG. 9A is a flowchart illustrating an example operation of performing ID card authentication in an application for ticket use according to one or more embodiment(s).

Referring to FIG. 9A, in operation 902, according to an embodiment, the user 301 may select a registered ticket. According to an embodiment, the user 301 may, for example, swipe up the screen of the electronic device 201 to execute the application 350 and may select the ticket type card displayed on the quick execution screen (or QA screen) of the application 350 as a registered ticket.

In operation 904, according to an embodiment, the user 301 may enter the detailed screen of the selected ticket through a predetermined input (e.g., a touch input on the ticket type card) for the selected ticket on the quick execution screen. The detailed screen of the selected ticket may be entered to obtain admission ticket data (e.g., QR code or barcode).

In operation 906, according to an embodiment, the application 350 may request ticket information about the selected ticket from the application server 340 based on entering the detailed screen of the selected ticket. According to an embodiment, the application 350 may request to provide ticket information by transmitting the content ID to the application server 340.

In operation 908, according to an embodiment, the application server 340 may transmit the ticket information to the application 350 in response to the ticket information request of the application 350. According to an embodiment, the ticket information may include the content ID and first ID information (e.g., the first hash value) registered corresponding to the content ID.

In operation 910, according to an embodiment, the application 350 may load the ID card module 360. According to an embodiment, the ID card module 360 may include, e.g., an SDK related to ID card verification and may obtain and store information related to the ID card from the external authentication server 380. According to an embodiment, the application 350 may load an ID module to use the information related to the ID card.

In operation 912, according to an embodiment, the ID card module 360 is a module operated in the secure area (e.g., TEE) and may request an identity authentication operation from the biometric module 370 to allow access by the authenticated user. The biometric recognition module 370 may perform an identity authentication operation based on biometric authentication based on a request of the ID card module 360. For example, the biometric module 370 may recognize the fingerprint, iris, or face of the user 301 and perform identity authentication by comparing the recognition result with pre-stored the information.

In operation 914, according to an embodiment, the biometric module 370 may provide information indicating that the identity authentication is successful to the ID card module 360 based on the success of the identity authentication. The biometric module 370 may provide information indicating that the identity authentication has failed to the ID card module 360 based on the failure of the identity authentication.

In operation 916, according to an embodiment, the ID card module 360 may allow access to the ID card module 360 for the application 350 based on receiving the information indicating that identity authentication has been successful. According to an embodiment, the ID card module 360 may not allow access to the ID card module 360 for the application 350 based on receiving the information indicating that identity authentication has failed. If access to the ID card module 360 is not allowed, the application 350 may not obtain the second ID information from the ID card module 360, and thus the ticket may not be used.

In operation 918, according to an embodiment, the application 350 may request the second ID information from the ID card module 360 based on the access being allowed of the ID card module 360. According to an embodiment, the second ID information may be ID information associated with the user 301 who is the ticket user.

In operation 920, according to an embodiment, the ID card module 360 may generate the second hash value based on the user 301's ID card (or ID card-related information) registered in the ID card module 360 based on the request of the application 350. For example, the ID card module 360 may generate the second hash value based on the information (e.g., user face information or user ID information) included in the user 301's ID card.

In operation 922, according to an embodiment, the ID card module 360 may request authentication for the second hash value from the authentication server 380.

In operation 924, according to an embodiment, the authentication server 380 may transmit an authentication success message to the ID card module 360 in response to a request of the ID card module 360. According to an embodiment, the authentication server 380 may determine whether the second hash value is associated with or corresponds to the user 301's ID card (or the information included in the ID card) stored in the authentication server 380, based on the request of the ID card module 360. In case that the second hash value is associated with or corresponds to the user 301's ID card stored in the authentication server 380, the authentication server 380 may transmit an authentication success message to the ID card module 360. In case that the second hash value is not associated with or does not correspond to the user 301's ID card stored in the authentication server 380, the authentication server 380 may transmit an authentication failure message to the ID card module 360.

In operation 926, according to an embodiment, the ID card module 360 may transmit second ID information including the second hash value to the application 350 based on receiving the authentication success message from the authentication server 380. According to an embodiment, based on receiving the authentication failure message from the authentication server 380, the ID card module 360 may transmit a message indicating that it is not permitted to provide the second ID information to the application 350 because the second hash value for which authentication has failed may not be used. In this case, the application 350 may not obtain the second ID information from the ID card module 360, and thus use the ticket is not permitted.

In operation 928, according to an embodiment, the application 350 may perform ID card authentication based on the content ID and the second hash value included in the second ID information. According to an embodiment, the application 350 may compare first ID information (e.g., the first hash value) and second ID information (e.g., the second hash value) for the ticket corresponding to the content ID. For example, the application 350 may compare whether the first hash value received in operation 908 corresponds to the second hash value obtained in operation 926. The application 350 may perform the operation illustrated in FIG. 9B based on the ID card authentication result through comparison.

FIG. 9B is a flowchart illustrating an example operation based on an ID card authentication result of a wallet application according to one or more embodiment(s).

Referring to FIG. 9B, operation 930 may be an operation performed following operation 928 of FIG. 9A. In operation 920, according to an embodiment, the application 350 may determine whether ID card authentication is successful.

According to an embodiment, in cased that the first hash value received in operation 908 of FIG. 9A and the second hash value obtained in operation 926 do not correspond to each other, the application 350 may determine that ID card authentication has failed, and output a notification message indicating that ID card authentication has failed to the display (e.g., the display 220 of FIG. 2A) in operation 944.

According to an embodiment, in case that the first hash value received in operation 908 of FIG. 9A and the second hash value obtained in operation 926 correspond to each other, the application 350 may determine that ID card authentication is successful and perform operation 932.

In operation 932, according to an embodiment, the application 350 may transmit a request message for requesting admission ticket data to the application server 340 based on the success of the ID card authentication. According to an embodiment, the request message may include the content ID of the ticket.

In operation 934, according to an embodiment, the application server 340 may transmit a request message for requesting admission ticket data to the ticket vendor 320 based on the request message of the application 350. According to an embodiment, the request message transmitted by the application server 340 may include the ref ID corresponding to the content ID of the ticket.

In operation 936, according to an embodiment, the ticket vendor 320 may transmit the admission ticket data to the application server 340 in response to the request message. According to an embodiment, the ticket vendor 320 may identify the ticket based on the ref ID and generate admission ticket data corresponding to the identified ticket. For example, the admission ticket data may include a barcode or QR code or may include a dynamic barcode or dynamic QR code that is valid for a predetermined time to enhance security. According to an embodiment, the ticket vendor 320 may transmit the admission ticket data to the application server 340 together with the ref ID.

In operation 938, according to an embodiment, the application server 340 may transmit the admission ticket data received from the ticket vendor 320 to the application 350. According to an embodiment, the application server 340 may transmit the content ID together with the admission ticket data to the application 350.

According to an embodiment in operation 940, the application 350 may activate the admission ticket based on the admission ticket data. According to an embodiment, the operation of activating the admission ticket may include at least one of an operation of displaying the admission ticket data on the screen, an operation of displaying the admission ticket data larger (e.g., zoom-in or expanding) or brighter, or an operation of adding an authentication mark to the admission ticket data and displaying it. For example, the authentication mark may include a UI authentication mark indicating that the ticket user's ID card authentication has been completed or indicating that the ticket user is the authenticated user.

In operation 942, according to an embodiment, the performance host 310 may enable selection and admission of a valid audience without a separate ID authentication procedure by scanning the admission ticket for which ID card authentication has been completed.

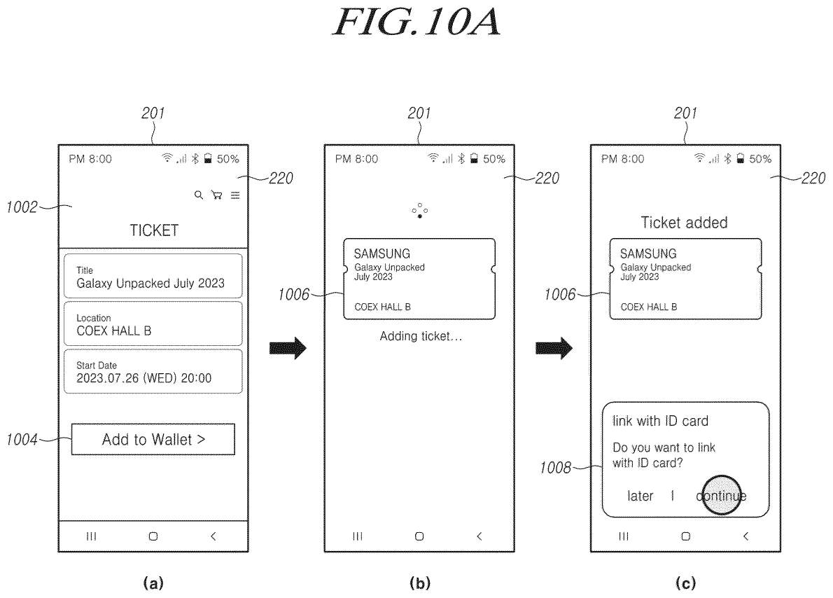

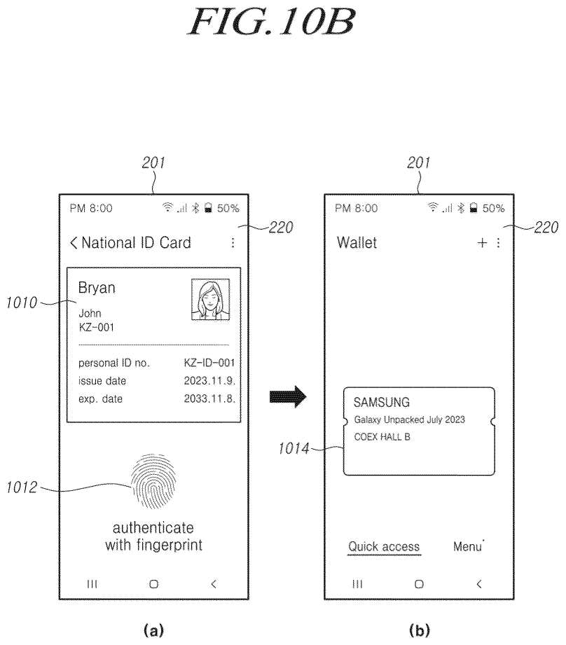

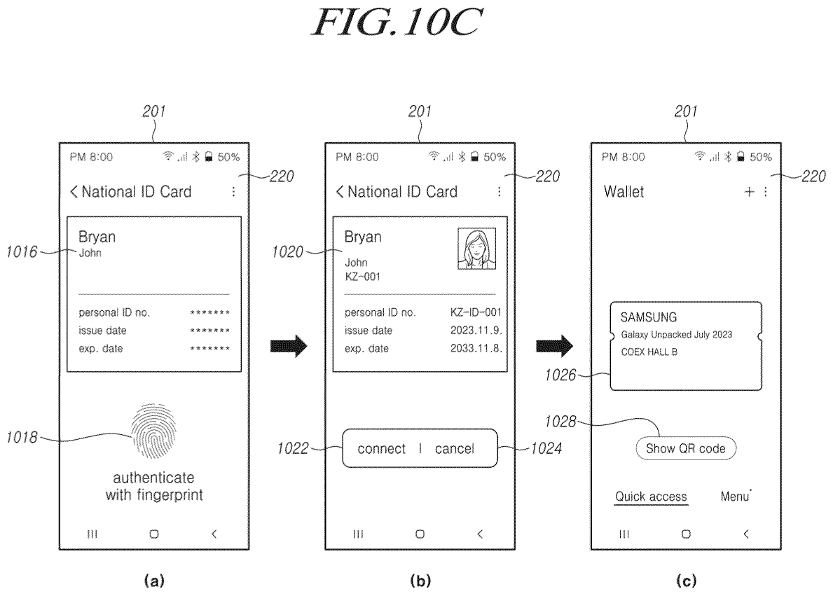

FIG. 10A is a view illustrating an example UI screen for adding a ticket to an application according to one or more embodiment(s).

Referring to screen (a) illustrated in FIG. 10A, according to an embodiment, the user (e.g., the user 301 of FIG. 4) may purchase a ticket through a ticket purchase platform (e.g., an online website or application) of a ticket vendor (or a partner server) (e.g., the ticket vendor 320 of FIG. 4) in the electronic device 201. The electronic device 201 may display the information 1002 about the purchased ticket and a UI for registering the purchased ticket in an application (e.g., the application 350 of FIG. 4), e.g., the Add to Wallet button 1004, on the display 220 based on the completion of the ticket purchase.

According to an embodiment, the information 1002 about the purchased ticket is information stored in the ticket vendor and may include Title information (performance, event, or exhibition name information), Location information (performance, event, or exhibition venue information), or Date/Time information (performance, event, or exhibition schedule information).

According to an embodiment, the electronic device 201 may output screen (b) based on the Add to Wallet button 1004 being touched, selected, or pressed by the user.

Referring to screen (b) illustrated in FIG. 10A, according to an embodiment, the electronic device 201 may display a UI indicating that the purchased ticket is registered as the ticket type card in the application 350. For example, the electronic device 201 may output, to the display 220, a message (e.g., Adding ticket . . . ) indicating that the ticket 1006 is being added to the application 350 and/or graphic information while displaying the ticket (or ticket type card) 1006.

According to an embodiment, based on completion of adding the ticket 1006 to the application, the electronic device 201 may output screen (c) as illustrated in FIG. 10A.

Referring to screen (c) illustrated in FIG. 10A, according to an embodiment, the electronic device 201 may display the ticket 1006 added to the application and a message (e.g., Ticket added) indicating that the ticket has been added on the display 220.

According to an embodiment, the electronic device 201 may display, on the display 220, a message 1008 (e.g., Do you want to link to the ID card?Later|Continue) asking the user whether to link (e.g., connect) the added ticket 1006 to the ID card.

According to an embodiment, based on selection to not link the added ticket 1006 to the ID card (e.g., selecting ‘Later’), the electronic device 201 may output a message indicating that the ticket 1006 has been registered without linkage with the ID card on the display 220.

According to an embodiment, based on the electronic device 201 selecting to link the added ticket 1006 to the ID card (e.g., selecting ‘Continue’), the electronic device 201 may output a screen for ID card linkage on the display 220 as illustrated in FIG. 10B or 10C.

FIG. 10B is a view illustrating an example UI screen for linking ID information to a ticket according to one or more embodiment(s).

Referring to screen (a) illustrated in FIG. 10B, according to an embodiment, the electronic device 201 may display an ID card 1010 (e.g., National ID Card) to be linked to the ticket (e.g., the ticket 1006 of screen (c) illustrated in FIG. 10A) on the screen. The ID card 1010 may be provided from the ID card module 360 included in the application 350. The electronic device 201 may link the ID card 1010 to the ticket through identity authentication.

According to an embodiment, the electronic device 201 may display a UI for prompting biometric authentication on the display 220. For example, the electronic device 201 may display a graphic element 1012 and/or a message (e.g., authenticate with a fingerprint) for fingerprint authentication on the display 220.

According to an embodiment, in case that fingerprint authentication fails, the electronic device 201 may output a message indicating that fingerprint authentication fails, and the ID card 1010 may not be linked to the ticket 1014.

According to an embodiment, in case that fingerprint authentication is successful, the electronic device 201 may output screen (b) as illustrated in FIG. 10B on the display 220.

Referring to screen (b) illustrated in FIG. 10B(b), according to an embodiment, the electronic device 201 may display an ID card linked ticket 1014 generated by linking the ID card 1010 to the ticket. According to an embodiment, when the ID card linked ticket 1014 is selected by the user (e.g., the user 301 of FIG. 5), the admission ticket may be displayed after identity authentication such as biometric authentication. The admission ticket may include admission ticket data (e.g., a barcode or QR code, a dynamic barcode or dynamic QR code, or the admission ticket data of operation 518 of FIG. 5). According to an embodiment, the admission ticket data may include a UI authentication mark indicating that the ID card authentication of the ticket user is completed or indicating that the ticket user is the authenticated user. In case that the admission ticket data is used, the user may be admitted to the performance without presenting an ID card, and the performance host (e.g., the performance host 310 of FIG. 5) may conveniently select and admit valid audiences simply by scanning or checking the admission ticket data.

FIG. 10C is a view illustrating an example UI screen for linking ID information to a ticket through identifying ID information according to one or more embodiment(s).

According to an embodiment, in case that the electronic device 201 selects to link (e.g., connect) the ticket 1006 added in on screen (c) of FIG. 10A to the ID card (e.g., selecting ‘Continue’), the electronic device 201 may output screen (a) as illustrated in FIG. 10C for ID card linkage on the display 220.

Referring to screen (a) illustrated in FIG. 10C, according to an embodiment, the electronic device 201 may display an ID card (e.g., a National ID Card) 1016 to be linked to the ticket 1006 on the screen. The ID card 1016 may be provided from the ID card module 360 included in the application (e.g., the application 350 of FIG. 4). According to an embodiment, the ID card 1016 may be in a state in which personal information (e.g., face information, personal ID number, issuance date, or expiration date) other than user ID information (e.g., name) is not displayed or may be hidden by special characters. In some cases, a portion of the user ID information (e.g., a portion of the name) may not be displayed or may be hidden by special characters.

According to an embodiment, the electronic device 201 may display a UI for prompting biometric authentication on the display 220 so that the ID card 1016 is linked to the ticket 1006 through identity authentication. For example, the electronic device 201 may display a graphic element 1018 and/or a message (e.g., authenticate with a fingerprint) for fingerprint authentication on the display 220. According to an embodiment, the biometric authentication of the electronic device 201 is not limited to fingerprint authentication but may include various biometric authentication such as iris authentication, voice authentication, or face authentication. According to an embodiment, in case that biometric authentication is impossible according to the user (e.g., a disabled person), the second authentication means may be used. For example, the second authentication means may be for performing authentication other than biometric authentication for performing user authentication.

According to an embodiment, in case that fingerprint authentication fails, the electronic device 201 may output a message indicating that the fingerprint authentication fails and the ID card 1016 may not be linked to the ticket 1006 to the display 220.

According to an embodiment, in case that fingerprint authentication is successful, the electronic device 201 may output screen (b) as illustrated in FIG. 10C on the display 220.

Referring to screen (b) illustrated in FIG. 10C, the electronic device 201 may display an ID card 1020 in which personal information is disclosed based on the success of the fingerprint authentication. The ID card 1020 may be in a state in which not only user ID information (e.g., name) but also the remaining personal information (e.g., face information, personal ID number, issuance date, or expiration date) is disclosed.

According to an embodiment, the electronic device 201 may display a UI (e.g., a Link 1022′ and/or ‘Cancel 1024’ button) asking whether to link the ID card 1020 to the ticket 1006.

According to an embodiment, based on selecting not to link the ID card 1020 to the ticket 1006 (e.g., selecting the ‘Cancel 1024’ button), the electronic device 201 may output a message indicating that the ticket 1006 has been registered without linking the ID card 1020 on the display 220.

According to an embodiment, based on the electronic device 201 selecting to link the ID card 1020 to the ticket 1006 (e.g., selecting the ‘Link 1022’ button), the electronic device 201 may output screen (c) as illustrated in FIG. 10C to the display 220.

Referring to screen (c) illustrated in FIG. 10C, the electronic device 201 may display the ID card linked ticket 1026 generated by linking the ID card 1020 to the ticket 1006. According to an embodiment, in case that the ID card linked ticket 1026 is selected or a predetermined icon, button, or graphic object (e.g., Show QR code 1028) is selected by the user, the admission ticket may be displayed. The admission ticket may be displayed after identity authentication such as biometric authentication. The admission ticket may include admission ticket data (e.g., a barcode or QR code, or a dynamic barcode or dynamic QR code).

According to an embodiment, the admission ticket data may include a UI authentication mark indicating that the ID card authentication of the ticket user is completed or indicating that the ticket user is the authenticated user. In case that the admission ticket data is used, the user may be admitted to the performance without presenting an ID card, and the performance host (e.g., the performance host 310 of FIG. 5) may conveniently select and admit valid audiences simply by scanning or checking the admission ticket data.

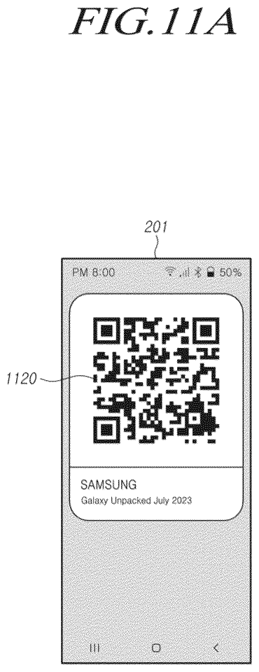

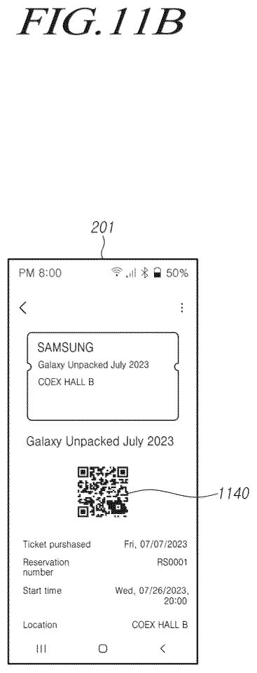

FIGS. 11A and 11B is a are views illustrating an example UI screen of an admission ticket displayed on an application according to one or more embodiment(s).

Referring to FIG. 11A, the admission ticket data included in the admission ticket may include a QR code (or a dynamic QR code) 1120. Upon entry, the QR code 1120 may be scanned by the performance host (e.g., the performance host 310 of FIG. 5).

Referring to FIG. 11B, a QR code 1140 may be displayed on the detailed screen of the ticket. According to an embodiment, in case that the QR code 1140 is selected by an input of the user (e.g., the user 301 of FIG. 5) such as a touch input, an enlarged QR code 1120 may be displayed as illustrated in FIG. 11A.

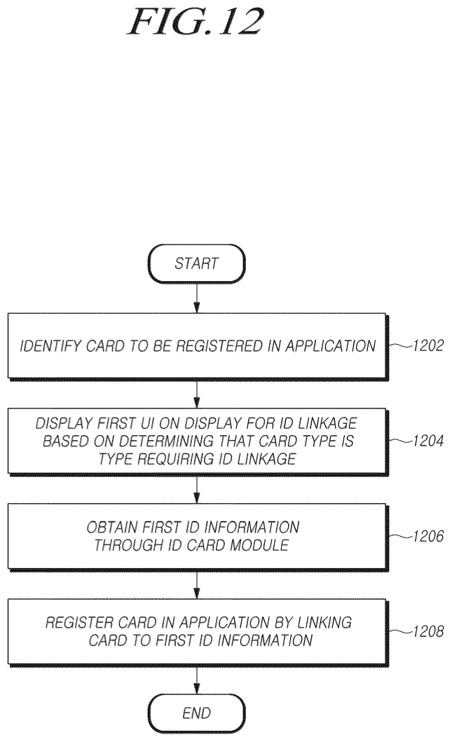

Hereinafter, operations of an electronic device (e.g., the electronic device 201 of FIG. 2A) are described with reference to FIGS. 12 to 14B.

According to an embodiment, the operations illustrated in FIGS. 12 to 14B may be understood as being performed by a processor (e.g., the processor 240 of FIG. 2A) of the electronic device and may include operations performed through an application (e.g., the application 350 of FIG. 4). The operations illustrated in each of FIGS. 12 to 14B may be performed in various orders without being limited to the illustrated order. According to an embodiment, at least some of the operations illustrated in each of FIGS. 12 to 14B may be omitted, or more operations may be performed than those illustrated in each of FIGS. 12 to 14B.

FIG. 12 is a flowchart illustrating an example operation of an electronic device for registering a ticket type card according to one or more embodiment(s).

Referring to FIG. 12, according to an embodiment, in operation 1202, the electronic device may identify a card to be registered in an application (e.g., the application 350 of FIG. 4).

According to an embodiment, the electronic device may receive a card registration request message from an application server (e.g., the application server 340 of FIG. 2B) and identify the information (e.g., a card identifier and/or card information corresponding to the card to be registered, such as the content ID) about the card to be registered based on the card registration request message. According to an embodiment, the electronic device may display the card to be registered on the display (e.g., the display 220 of FIG. 2A) based on the identified information.

According to an embodiment, the card registration request message may be received based on a card registration request of the user (e.g., the user 301 of FIG. 4). For example, the card registration request message may be received based on the user making a UI-based input (e.g., selecting the ‘Add to Wallet’ button) after purchasing a ticket on the ticket purchase platform.

In operation 1204, according to an embodiment, based on determining that the type of card to be registered is the type requiring ID card linkage, the electronic device 201 may display, on the display 220, a first UI (e.g., the message on screen (c) illustrated in FIG. 10A (“Do you want to link with the ID card?” Later|Continue) 1008) for ID card linkage. According to an embodiment, the type of card to be registered may vary. For example, the type of card to be registered may correspond to any one of a first type indicating a payment means (e.g., a credit card or a debit card), a second type indicating a ticket, a third type indicating a boarding pass for a transportation means (e.g., a bus, a train, or an airplane), or a fourth type indicating a coupon. The type requiring ID card linkage may be the second type, but if the above-described ticket registration and use method are applicable, it may be another type (e.g., the third type).

In operation 1206, according to an embodiment, the electronic device may obtain the first ID information through the ID module (e.g., the ID card module 360 of FIG. 2A) based on the reception of the user input in response to the first prompt (e.g., selecting ‘Continue’ in the message 1008 illustrated in FIG. 10A). According to an embodiment, the electronic device may obtain the information related to the ID card from the authentication server (e.g., the authentication server 380 of FIG. 4) through the ID card module 360 and generate first ID information based on the obtained information. For example, the electronic device may obtain the information related to the ID card from the authentication server through identity authentication (or user authentication or identity authentication). According to an embodiment, the electronic device may generate the first ID information to include original data of the ID card included in the information related to the ID card or a data value generated based on data or information included in the ID card. According to an embodiment, the information related to the ID card may include data capable of proving the user's identity, and is not limited to the embodiment, and may include various information such as the user's social security number, the user's resident registration number, and the user's driver's license number, and these information may be obtained in the form of encrypted data. According to an embodiment, the electronic device may generate the first ID information based on the information related to the ID card obtained from the authentication server through the ID card module 360. For example, the first ID information may include the first hash value.

In operation 1208, according to an embodiment, the electronic device may register the card in the application by linking the card to the first ID information. According to an embodiment, the electronic device may transmit a card registration response message indicating that the card has been registered in the application server in association with the first ID information based on the addition or registration of the card in the application. For example, the card registration response message may include the content ID and the first hash value corresponding to the card registered in the application 350, and the application server may store the first hash value as ID information corresponding to the content ID based on the card registration response message.

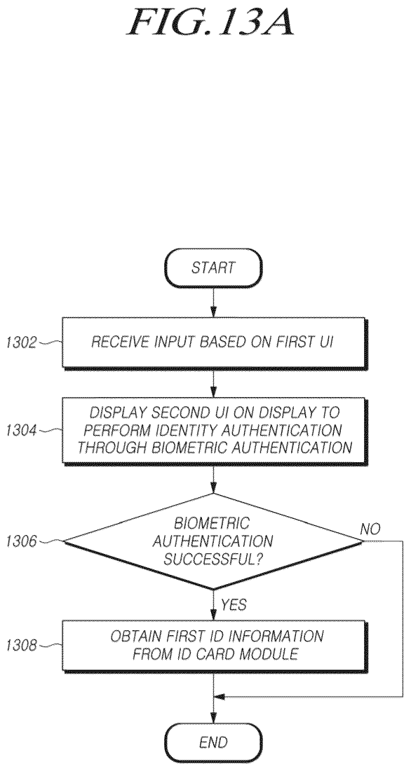

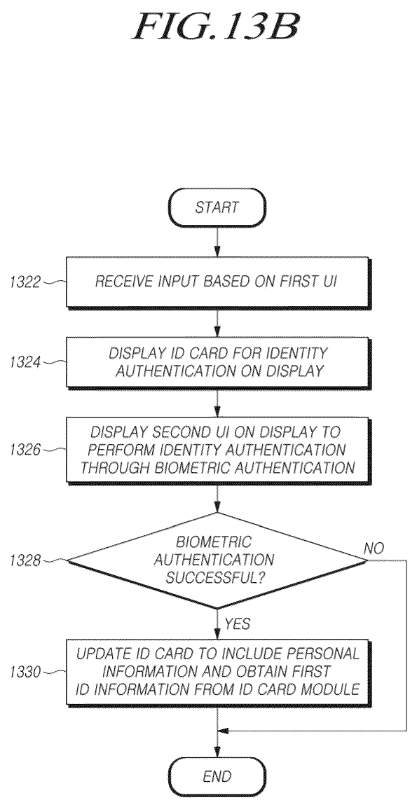

FIG. 13A is a flowchart illustrating an example operation of an electronic device for obtaining first ID information according to one or more embodiment(s).

According to an embodiment, the operations illustrated in FIG. 13A may be detailed operations of operation 1206 of FIG. 12.

Referring to FIG. 13A, in operation 1302, according to an embodiment, the electronic device may receive a user input in response to the first prompt. For example, the user input in response to the first prompt may indicate an input indicating the linkage with the ID card to the card to be registered (e.g., selecting ‘Continue’ in the message 1008 illustrated in screen (c) of FIG. 10A).

In operation 1304, according to an embodiment, the electronic device may display, on the display (e.g., the display 220 of FIG. 2A), a second UI (e.g., a graphic element 1018 and/or a message (e.g., authenticate with a fingerprint) for fingerprint authentication illustrated in screen (a) of FIG. 10C) so that identity authentication is performed through biometric authentication. According to an embodiment, biometric authentication may be performed through fingerprint authentication but may be performed through iris authentication, voice authentication, or face authentication in addition to fingerprint authentication. According to an embodiment, the authentication method for identity authentication is not limited to biometric authentication, and other types of authentication (e.g., password authentication, pattern authentication, or code authentication) may be performed.

In operation 1306, according to an embodiment, the electronic device may determine whether biometric authentication is successful through the second UI. According to an embodiment, the electronic device may recognize the fingerprint, iris, or face of the user (e.g., the user 301 of FIG. 4) using the biometric module (e.g., the biometric module 370 of FIG. 2A) and determine whether biometric authentication is successful based on whether the recognized result corresponds to pre-stored the information.

In operation 1308, according to an embodiment, the electronic device may obtain the first ID information (e.g., the first hash value) from the ID card module (e.g., the ID card module 360 of FIG. 2B) based on the successful biometric authentication.

FIG. 13B is a flowchart illustrating an example operation of an electronic device for obtaining first ID information based on ID card display according to one or more embodiment(s).

According to an embodiment, the operations illustrated in FIG. 13B may be detailed operations of operation 1206 of FIG. 12.

Referring to FIG. 13B, according to an embodiment, in operation 1322, the electronic device may receive an input based on the first UI. For example, the input based on the first UI may indicate an input indicating the linkage with the ID card to the card to be registered (e.g., selecting ‘Continue’ in the message 1008 illustrated in (c) of FIG. 10A).

In operation 1324, according to an embodiment, the electronic device may display an ID card for (e.g., the National ID Card 1016 illustrated in FIG. 10C(a)) for identity authentication on the display (e.g., the display 220 of FIG. 2A). According to an embodiment, the ID card may be in a state in which at least portion of personal information is not displayed or is hidden by special characters. For example, in the ID card, at least a portion of the name of the ID card holder may be displayed, and the remaining personal information may be hidden.

In operation 1326, according to an embodiment, the electronic device may display the second UI on the display so that identity authentication is performed through biometric authentication. According to an embodiment, biometric authentication may include fingerprint, iris, or face authentication. According to an embodiment, the second UI may include a UI for prompting biometric authentication. For example, in case that the biometric authentication is fingerprint authentication, the second UI may include a graphic element 1018 and/or a message (e.g., authenticate with a fingerprint) for fingerprint authentication of FIG. 10B.

In operation 1328, according to an embodiment, the electronic device may determine whether biometric authentication is successful through the second UI. According to an embodiment, the electronic device may recognize the fingerprint, iris, or face of the user (e.g., the user 301 of FIG. 4) using the biometric recognition module (e.g., the biometric recognition module 370 of FIG. 2A), and determine whether biometric authentication is successful based on whether the recognized result corresponds to pre-stored information.

In operation 1330, according to an embodiment, the electronic device may update the ID card to include personal information based on the success of the biometric authentication and obtain the first ID information (e.g., the first hash value) from the ID card module (e.g., the ID card module 360 of FIG. 2A).

According to an embodiment, the electronic device may update the ID card so that personal information is disclosed, as illustrated in screen (b) of FIG. 10C.

According to an embodiment, the electronic device may obtain the first ID information based on the user's selection. For example, the electronic device may or may not obtain the first ID information from the ID card module, according to the user's selection based on the updated ID card (or ID card in which personal information is disclosed).

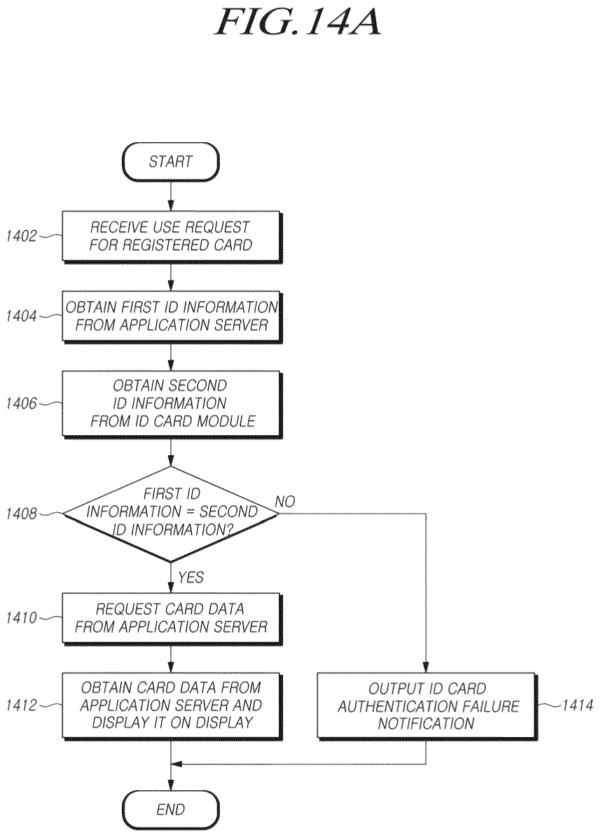

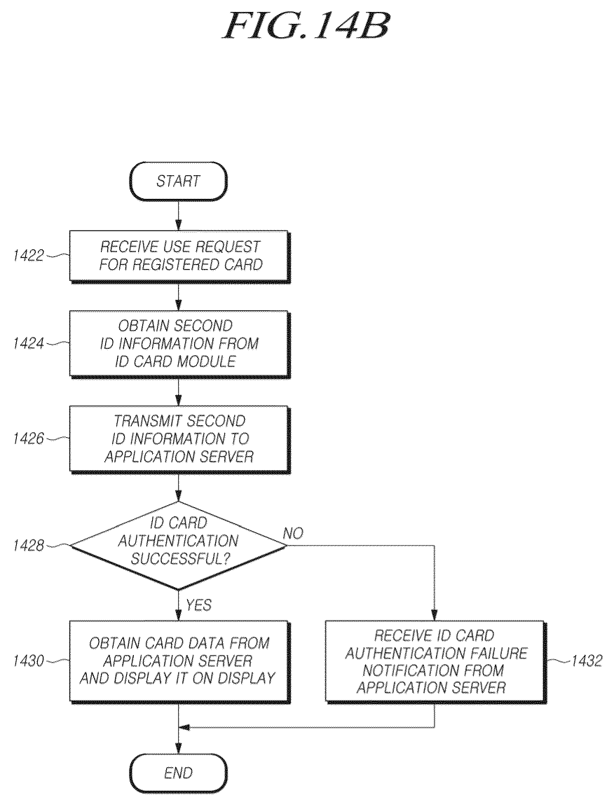

FIG. 14A is a flowchart illustrating an example operation of an electronic device using a ticket type card based on ID card authentication of an electronic device according to one or more embodiment(s).

Referring to FIG. 14A, in operation 1402, according to an embodiment, the electronic device may receive a use request for a registered card (e.g., a ticket type card). According to an embodiment, the electronic device may receive a use request based on the card being selected by the user (e.g., the user 301 of FIG. 6) in the application (e.g., the application 350 of FIG. 6) or based on entering the detailed screen of the ticket type card.

In operation 1404, according to an embodiment, the electronic device may obtain the first ID information from the application server (e.g., the application server 340 of FIG. 6). For example, the first ID information may be registered in the application server at the time of registration of the ticket type card (or execution of operation 1208 of FIG. 12).

According to an embodiment, the electronic device may request the application server to provide the first ID information (e.g., the first hash value) based on the ID information (e.g., the content ID) about the ticket type card and obtain the first ID information from the application server in response to the request.

According to an embodiment, based on the first ID information being stored in the memory of the electronic device (e.g., the memory 230 of FIG. 2A) at the time of registration of the ticket type card, the electronic device may obtain the first ID information from the memory without requesting the first ID information from the application server.

In operation 1406, according to an embodiment, the electronic device may obtain second ID information from the ID card module through identity authentication. According to an embodiment, the electronic device may obtain the second ID information in a method similar to the method for obtaining the first ID information. For example, the electronic device may perform biometric authentication through the biometric module (e.g., the biometric module 370 of FIG. 2A), and obtain second ID information (e.g., second hash value) through the ID card module 360 from the authentication server based on the success of the biometric authentication.

In operation 1408, according to an embodiment, the electronic device may determine whether the first ID information corresponds to the second ID information. For example, the electronic device may determine whether the first ID information and the second ID information correspond based on the comparison result of the first and second hash values respectively corresponding to the first ID information and the second ID information.

In operation 1410, according to an embodiment, the electronic device may request card data from the application server based on the first ID information and the second ID information corresponding to each other. According to an embodiment, the card data of the ticket type card may correspond to admission ticket data. According to an embodiment, the electronic device may request the application server to provide card data corresponding to the content ID by transmitting the content ID to the application server.

In operation 1412, according to an embodiment, the electronic device may obtain card data from the application server and display the same on the display (e.g., the display 220 of FIG. 2A). For example, the electronic device may include a barcode or QR code corresponding to the admission ticket data, or other types of admission authentication data from the application server. The barcode or QR code may be a dynamic barcode or dynamic QR code that is valid for a predetermined time.

In operation 1414, according to an embodiment, the electronic device may output an ID card authentication failure notification message based on the first ID information and the second ID information not corresponding to each other to the display. According to an embodiment, in case that ID card authentication fails, it may be impossible to use the ticket type card.

FIG. 14B is a flowchart illustrating an example operation of an electronic device using a ticket type card based on ID card authentication of an application server according to one or more embodiment(s).

Referring to FIG. 14B, in operation 1422, according to an embodiment, the electronic device may receive a use request for a registered card (e.g., a ticket type card). According to an embodiment, the electronic device may receive a use request based on the card being selected by the user (e.g., the user 301 of FIG. 5) in the application (e.g., the application 350 of FIG. 5) or based on entering the detailed screen of the ticket type card.

In operation 1424, according to an embodiment, the electronic device may obtain second ID information from the ID card module through identity authentication. According to an embodiment, the electronic device 201 may perform biometric authentication through the biometric module (e.g., the biometric module 370 of FIG. 2A) and obtain second ID information (e.g., second hash value) from the authentication server through the ID card module (e.g., the ID card module 360 of FIG. 2A) based on the success of the biometric authentication.

In operation 1426, according to an embodiment, the electronic device 201 may transmit the second ID information to the application server (e.g., the application server 340 of FIG. 2B). According to an embodiment, the electronic device may request the application server to provide card data through ID card authentication by transmitting ID information (e.g., content ID) and second ID information (e.g., second hash value) of the ticket type card to the application server.

In operation 1428, according to an embodiment, the electronic device may determine whether ID card authentication through the application server is successful. According to an embodiment, the electronic device may receive an ID card authentication result from the application server and determine whether ID card authentication has been successful based on the received ID card authentication result.

According to an embodiment, the ID card authentication through the application server may be performed based on whether the first ID information (e.g., the first hash value) registered in the application server at the time of registration of the ticket type card (or at the time of performing operation 1208 of FIG. 12) corresponds to the second ID information (e.g., the second hash value) transmitted by the electronic device in operation 1426.

According to an embodiment, in case that the first ID information and the second ID information correspond to each other, the application server may transmit an ID card authentication success notification message indicating that ID card authentication has been successful to the electronic device. The application server may obtain card data (e.g., the admission ticket data such as a barcode or QR code) from the ticket vendor (e.g., the ticket vendor (or partner server) 320 of FIG. 5) and transmit it to the electronic device based on the success of the ID card authentication.

In operation 1430, according to an embodiment, the electronic device may receive the ID card authentication success notification message from the application server to identify that ID card authentication has been successful, obtain card data from the application server, and display the card data on the display (e.g., the display 220 of FIG. 2A).

According to an embodiment, in case that the first ID information and the second ID information do not correspond, the application server may transmit an ID card authentication failure notification message indicating that ID card authentication has failed to the electronic device. The application server may not perform the operation of obtaining card data from the ticket vendor based on the failure of the ID card authentication.

In operation 1432, according to an embodiment, the electronic device may receive an ID card authentication failure notification message from the application server to identify that ID card authentication has failed, and display a message indicating that ID card authentication has failed on the display.

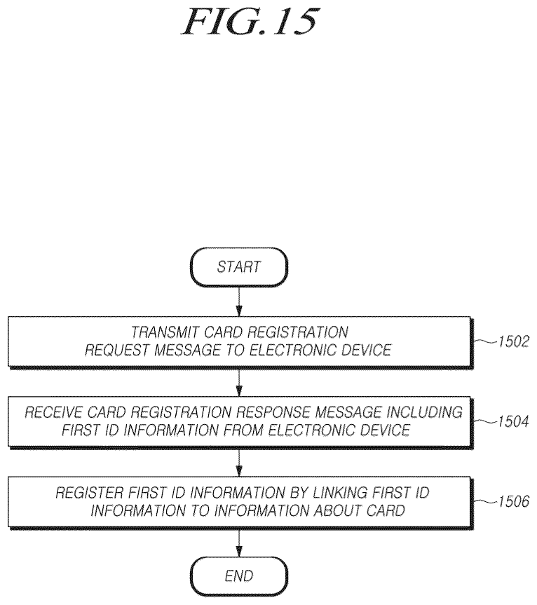

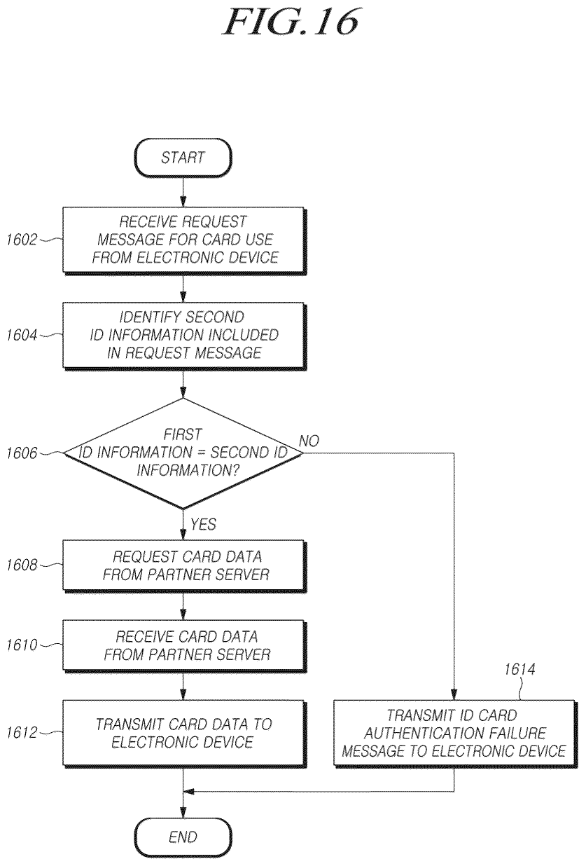

Hereinafter, the operation of the application server (e.g., the application server 340 of FIG. 2B) is described with reference to FIGS. 15 and 16.

According to an embodiment, the operations illustrated in FIGS. 15 and 16 may be understood as being performed by the processor of the application server (e.g., the processor 270 of FIG. 2B). The operations illustrated in FIGS. 15 and 16 may be performed in various orders without being limited to the illustrated order. According to an embodiment, at least some of the operations illustrated in each of FIGS. 15 and 16 may be omitted, or more operations may be performed than those illustrated in each of FIGS. 15 and 16.

FIG. 15 is a flowchart illustrating an example operation of an application server according to one or more embodiment(s).

Referring to FIG. 15, in operation 1502, according to an embodiment, the application server may transmit, to the electronic device, a card registration request message for requesting to register a card in the application (e.g., the application 350 of FIG. 4) of the electronic device (e.g., the electronic device 201 of FIG. 2A). According to an embodiment, the card registration request message may include information about a registration-requested card (e.g., a card identifier and/or card information corresponding to the registration-requested card such as the content ID).

In operation 1504, according to an embodiment, the application server may receive a card registration response message including the first ID information from the electronic device in response to the card registration request message. According to an embodiment, the application server may receive a card registration response message including the first ID information from the electronic device based on the registration-requested card is a type (e.g., ticket type) requiring ID card linkage. According to an embodiment, the card registration response message may include a card identifier (e.g., the content ID) together with the first ID information.

In operation 1506, according to an embodiment, the application server may register the first ID information in association with the information about the card. According to an embodiment, the application server may identify the card corresponding to the card identifier and store the first ID information as ID information corresponding to the identified card.

FIG. 16 is a flowchart illustrating an example ID card authentication operation of an application server according to one or more embodiment(s).

Referring to FIG. 16, in operation 1602, according to an embodiment, the application server may receive a request message for card use from an electronic device (e.g., the electronic device 201 of FIG. 2A). According to an embodiment, the request message may be a message for requesting ID card authentication for card use and may include second ID information associated with the card user.

In operation 1604, according to an embodiment, the application server may identify the second ID information included in the request message.

In operation 1606, according to an embodiment, the application server may perform an ID card authentication operation of determining whether the first ID information stored through the operation of FIG. 15 corresponds to the second ID information identified in operation 1604.

In operation 1608, according to an embodiment, the application server may identify that ID card authentication has been successful based on the first ID information and the second ID information corresponding to each other (e.g., matching ID information) and may request card data for card use from the partner server (e.g., the ticket vendor 320 of FIG. 5).

In operation 1610, according to an embodiment, the application server may receive card data from the partner server in response to requesting the card data.

In operation 1612, according to an embodiment, the application server may transmit card data received from the partner server to the electronic device.

According to an embodiment, based on determination in operation 1606 that the first ID information and the second ID information do not correspond (e.g., information do not match), the application server may identify that ID card authentication has failed.

In operation 1614, according to an embodiment, the application server may transmit an ID card authentication failure message to the electronic device based on the failure of ID card authentication.

A method for operating an electronic device 201 according to an embodiment may comprise identifying a card to be registered in an application 350, displaying, based on determining that a type of the card is a type that requires linkage with an ID card, a first UI for the linkage with the ID card on a display 220 of the electronic device 201, obtaining, based on an input based on the first UI being received, first ID information through an ID card module 360 included in the electronic device 201, and registering the card in the application 350 by linking the card to the first ID information.

According to an embodiment, identifying the card to be registered may include receiving a card registration request message from an application server, identifying information about the card to be registered based on the card registration request message, and displaying the card to be registered on the display 220 based on the identified information.

According to an embodiment, the type of the card to be registered may be a ticket type card.

According to an embodiment, obtaining the first ID information may include displaying 1304 a second UI on the display 220 to perform biometric authentication based on receiving an input to the first UI and, based on the biometric authentication through the second UI being successful, obtaining the first ID information from the ID card module 360.

Obtaining the first ID information may include based on the input based on the first UI being received 1322, displaying the ID card for the identity authentication on the display 220 through the ID card module 360, based on the display of the ID card, displaying a second UI for performing the identity authentication through biometric authentication on the display 220, and based on the biometric authentication being successful through the second UI, updating the ID card to include personal information through the ID card module 360 and generating the first ID information based on the personal information through the ID card module 360. The personal information may include information obtained from the authentication server.

According to an embodiment, generating the first ID information may include generating a first hash value based on the personal information through the ID card module 360, requesting authentication for the first hash value from the authentication server 380, and based on receiving a message indicating that authentication for the first hash value has been successful from the authentication server 380, generating the first ID information based on the first hash value through the ID card module 360.

According to an embodiment, the operation method of the electronic device 201 may further comprise transmitting, to an application server, a card registration response message indicating that the card is linked to the first ID information and is registered in the application 350, through the transceiver 201.

According to an embodiment, the operation method of the electronic device 201 may further include registering the card to be registered without linkage with the first ID information based on the failure of the biometric authentication through the second UI, and transmitting, to the application server 340, a card registration response message indicating that the card to be registered is registered in the application 350 without linkage with the first ID information.

According to an embodiment, the operation method of the electronic device 201 may further include performing ID card authentication based on receiving a use request for the registered card, obtaining card data for use of the registered card based on a success of ID card authentication, and displaying the card data on the display 220. The card data may include a QR code or a barcode.

According to an embodiment, obtaining the card data may include obtaining second ID information from the ID card module 360, determining whether the second ID information corresponds to the first ID information, identifying that the ID card authentication has been successful based on the second ID information corresponding to the first ID information, transmitting a request message for requesting the card data to the application server 340 based on the success of the ID card authentication, and obtaining the card data from the application server in response to the request message. The first ID information may include a first hash value, and the second ID information may include a second hash value.

According to an embodiment, the operation method of the electronic device 201 may further include identifying that the ID card authentication has failed based on the second ID information not corresponding to the first ID information, and outputting a notification message indicating that the ID card authentication has failed to the display 220 based on the failure of the ID card authentication.

A method for operating an application server 340 according to an embodiment may comprise transmitting a card registration request message for requesting to register a card in an application 350 of an electronic device 201 to an electronic device 201, in response to the card registration request message, receiving a card registration response message including first ID information from the electronic device 201, and registering the first ID information in association with information about the card.

According to an embodiment, each of the card registration request message and the card registration response message may include a card identifier corresponding to the card. The card may include a ticket type card.

According to an embodiment, the electronic device 201 may interwork with at least one external electronic device (e.g., a smart watch). At least one external electronic device may be used by the same user as the user of the electronic device 201. The electronic device 201 may perform a ticket registration and use operation associated with the above-described ID information, and may transmit the admission ticket data (e.g., a QR code or a barcode) of the application 350 to the at least one external electronic device. The at least one external electronic device may display admission ticket data received from the electronic device 201 through identity authentication through biometric authentication. Therefore, the user 301 may have convenience of using admission ticket data through at least one external electronic device instead of the electronic device 201.

According to various embodiments described above, since a ticket identity authenticated based on ID information may be used, it is possible to prevent ticket resale and theft and reduce the time and cost of ticket inspection by simplifying the admission process.

The electronic device according to various embodiments of the disclosure may be one of various types of electronic devices. Electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). As an example, a module may be software executed by a processor (e.g., the processor 120).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a transceiver;
a display;
at least one processor comprising processing circuitry; and
memory comprising instructions,
wherein the instructions, when executed by the at least one processor individually or collectively, cause the electronic device to:
identify a card in an application,
display, based on determining that the card is of a type that requires linkage with an ID card, a first user interface (UI) on the display, wherein the first UI is configured to request a user input,
obtain, based on the user input, a first ID information, and
register the card in the application by linking the card to the first ID information.

2. The electronic device of claim 1, wherein the instructions that, when executed by the at least one processor individually or collectively, cause the electronic device to:
receive a card registration request message from an application server through the transceiver,
identify information about the card based on the card registration request message, and
display the card on the display based on the identified information.

3. The electronic device of claim 1, wherein the instructions, when executed by the at least one processor individually or collectively, cause the electronic device to:
based on the card being a ticket type card, determine that the card is of the type that requires linkage with the ID card.

4. The electronic device of claim 1, wherein the instructions, when executed by the at least one processor individually or collectively, cause the electronic device to:
based on the user input, display a second UI for biometric authentication on the display, and
based on the biometric authentication, obtain the first ID information.

5. The electronic device of claim 1, wherein the instructions, when executed by the at least one processor individually or collectively, cause the electronic device to:
based on the user input, display the ID card for identity authentication on the display,
based on the display of the ID card, display a second UI for biometric authentication on the display, and
based on the biometric authentication being successful, update the ID card to include a personal information and obtain the first ID information based on the personal information,
wherein the personal information includes information obtained from an authentication server.

6. The electronic device of claim 5, wherein the instructions, when executed by the at least one processor individually or collectively, cause the electronic device to:
generate a first hash value based on the personal information,
request authentication for the first hash value from the authentication server, and
based on receiving a message indicating that authentication for the first hash value has been successful from the authentication server, generate the first ID information based on the first hash value.

7. The electronic device of claim 2, wherein the instructions, when executed by the at least one processor individually or collectively, cause the electronic device to:
transmit, a card registration response message to an application server via the transceiver,
wherein the card registration response message indicates that the card is linked to the first ID information and is registered in the application.

8. The electronic device of claim 4, wherein the instructions, when executed by the at least one processor individually or collectively, cause the electronic device to:
based on the biometric authentication failing, register the card in the application without linking the first ID information, and
transmit a card registration response message to the application server via the transceiver,
wherein the card registration response message indicates that the card is registered in the application without linking the first ID information.

9. The electronic device of claim 1, wherein the instructions, when executed by the at least one processor individually or collectively, cause the electronic device to:
based on receiving a request for use of the registered card, perform an ID card authentication, and
based on the ID card authentication being successful, display a card data for use of the registered card on the display,
wherein the card data includes a quick response (QR) code or a barcode.

10. The electronic device of claim 9, wherein the instructions, when executed by the at least one processor individually or collectively, cause the electronic device to:
obtain a second ID information,
determine whether the second ID information corresponds to the first ID information,
based on the second ID information corresponding to the first ID information, identify that the ID card authentication is successful,
based on the ID card authentication being successful, transmit a request message for requesting the card data to the application server via the transceiver, and
in response to the application server receiving the request message, obtain the card data from the application server via the transceiver,
wherein the first ID information includes a first hash value, and the second ID information includes a second hash value.

11. The electronic device of claim 10, wherein the instructions, when executed by the at least one processor individually or collectively, cause the electronic device to:
based on the second ID information not corresponding to the first ID information, identify that the ID card authentication has failed, and
based on a failure of the ID card authentication, output a notification message indicating that the ID card authentication has failed on the display.

12. An application server, comprising:
a transceiver;
at least one processor including processing circuitry;
memory comprising instructions,
wherein the instructions, when executed by the at least one processor individually or collectively, cause the application server to:
transmit a card registration request message to an electronic device via the transceiver;
in response to the electronic device receiving the card registration request message, receive a card registration response message including first ID information from the electronic device via the transceiver; and
register the first ID information in association with information about a card,
wherein the card registration request message is a request to register the card in an application of the electronic device.

13. The application server of claim 12, wherein
each of the card registration request message and the card registration response message includes a card identifier corresponding to the card, and]
wherein the card is a ticket type card.

14. The application server of claim 12,
wherein the instructions, when executed by the at least one processor individually or collectively, cause the application server to:
receive a request message for use of the card from the electronic device via the transceiver;
determine whether a second ID information included in the request message corresponds to the first ID information;
based on the second ID information corresponding to the first ID information, identify that an ID card authentication is successful;
based on the ID card authentication being successful, request card data for use of the card from a partner server via the transceiver; and
transmit the card data to the electronic device based on receiving the card data from the partner server through the transceiver, and
wherein the first ID information includes a first hash value, and the second ID information includes a second hash value.

15. The application server of claim 14,
wherein the instructions, when executed by the at least one processor individually or collectively, cause the application server to:
based on the second ID information not corresponding to the first ID information, identify that the ID card authentication has failed, and
based on a failure of the ID card authentication, transmit a notification message indicating that the ID card authentication has failed to the electronic device through the transceiver.

16. A method for operating an electronic device, the method comprising:
identifying a card to be registered in an application;
displaying, based on determining that the card is of a type that requires linkage with an ID card, a first user interface (UI) on a display of the electronic device,
wherein the first UI is configured to request a user input;
obtaining, based on the user input, a first ID information; and
registering the card in the application by linking the card to the first ID information.

17. The method of claim 16,
wherein obtaining the first ID information comprises:
based on the user input, displaying the ID card for an identity authentication on the display;
based on the display of the ID card, displaying a second UI for performing the identity authentication through a biometric authentication on the display; and
based on the biometric authentication being successful, updating the ID card to comprise a personal information and generating the first ID information based on the personal information,
wherein the personal information comprises information obtained from the authentication server.

18. The method of claim 17,
wherein generating the first ID information comprises:
generating a first hash value based on the personal information;
requesting authentication for the first hash value from the authentication server; and
based on receiving a message indicating that authentication for the first hash value has been successful from the authentication server, generating the first ID information based on the first hash value.

19. A method for operating an application server, the method comprising:
transmitting a card registration request message to an electronic device;
in response to the electronic device receiving the card registration request message, receiving a card registration response message including first ID information from the electronic device; and
registering the first ID information by linking the first ID information to information about a card,
wherein the card registration request message is a request to register the card in an application of the electronic device.

20. The method of claim 19,
wherein each of the card registration request message and the card registration response message includes a card identifier corresponding to the card, and
wherein the card is a ticket type card.
